(19) United States
(12) Patent Application Publication
(10) Pub. No.: US 2026/0292636 A1
(43) Pub. Date: Sep. 24, 2026

(54) Systems and Methods for Roaming Timeout Signaling for Seamless Roaming

(71) Applicant: Cisco Technology, Inc., San Jose, CA (US)

(72) Inventors: Binita Gupta, San Diego, CA (US); Brian Hart, Los Altos Hills, CA (US)

(21) Appl. No.: 19/577,187

(22) Filed: Mar. 24, 2026

Related U.S. Application Data
(60) Provisional application No. 63/776,897, filed on Mar. 24, 2025.

(51) Int. Cl. H04W 36/18; H04W 36/00; H04W 60/04

(52) U.S. Cl. CPC H04W 36/18; H04W 36/0016; H04W 60/04

(57) ABSTRACT

Systems and methods for roaming execution deadline signaling to facilitate seamless roaming within a wireless network may be provided by the present disclosure. A target access point multi-link device may receive a roaming preparation request from a client device seeking to transition between overlapping coverage areas. To manage network resources efficiently, the target access point multi-link device can determine a roaming timeout for the client device based on current load conditions or congestion levels. The target access point multi-link device might then generate a signaling frame containing the determined roaming timeout and transmit this frame to the client device. The signaling frame could encompass a seamless mobility domain element, a timeout interval element, or a link reconfiguration response. Consequently, the client device may perform the roaming execution prior to the expiration of the signaled deadline interval to ensure persistent connectivity.

### CROSS-REFERENCE TO RELATED APPLICATIONS

The present application claims the benefit and priority to U.S. Provisional Patent Application No. 63/776,897, filed Mar. 24, 2025, the entire contents of each are hereby incorporated by reference.

### FIELD

The present disclosure relates to roaming timeout signaling for seamless roaming. More particularly, the present disclosure relates to providing signaling options for indicating a roaming timeout (also referred to as a roaming execution deadline interval or roaming preparation timeout) to a non-access point multi-link device (non-AP MLD) for performing a roaming execution after a roaming preparation.

### BACKGROUND

Wireless local area networks (WLANs) have become an essential component of modern communication infrastructure, supporting a vast and growing number of connected devices, ranging from smartphones and laptop computers to other wireless clients. As users and their associated devices physically move through different coverage areas, such as within a large enterprise deployment, persistent and reliable connectivity is expected. To maintain this connectivity, wireless devices must seamlessly transition, or “roam,” from the coverage area of one access point to another. The ability to support smooth mobility is a useful performance factor in wireless networking environments.

The process of roaming (or BSS transition) inherently involves transitioning to a target access point and transferring the necessary context to ensure persistent data flow. As wireless standards have evolved to support higher throughput and better performance, new configurations such as Multi-Link Devices (MLDs) have been introduced to manage communications. To reduce service disruption and packet loss during these transitions, target access points must often be prepared in advance to accept an incoming roaming device. This preparation typically involves setting up links and reserving necessary network resources on the target access point prior to the actual execution of the roam.

Preparing a target access point for an incoming roam generally requires the allocation of finite network resources to manage the anticipated link setups and context transfers. However, efficient network operation dictates that such resources cannot be reserved indefinitely. If an access point reserves capacity for a roaming client for too long, those reserved resources are effectively wasted and remain unavailable to other active devices on the network. Consequently, network administrators and equipment manufacturers face an ongoing challenge in balancing the need for rapid, seamless roaming transitions with the overarching necessity of optimizing resource utilization and reducing network congestion across multiple access points

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1A is a schematic diagram of a network environment illustrating a client device roaming between access points in accordance with an embodiment of the disclosure;

FIG. 1B is a schematic diagram of a seamless mobility domain (SMD) environment in accordance with an embodiment of the disclosure;

FIG. 2 is a diagram illustrating an Open Systems Interconnection (OSI) model in accordance with various embodiments of the disclosure;

FIG. 3 is a diagram illustrating a client device roaming between overlapping coverage areas of multiple access points in accordance with an embodiment of the disclosure;

FIG. 4 is a block diagram illustrating a Seamless Mobility Domain (SMD) element format in accordance with various embodiments of the disclosure;

FIG. 5 is a block diagram illustrating a timeout interval element format in accordance with various embodiments of the disclosure;

FIG. 6 is a table illustrating timeout interval type field values in accordance with various embodiments of the disclosure;

FIG. 7 is a table illustrating a link reconfiguration response frame format in accordance with various embodiments of the disclosure;

FIG. 8 is a schematic diagram of a multi-link device network environment in accordance with an embodiment of the disclosure;

FIG. 9 is a flowchart showing a process for roaming execution deadline signaling for seamless roaming from the perspective of a network device in accordance with various embodiments of the disclosure;

FIG. 10 is a flowchart showing a process for seamless network roaming from the perspective of a client device in accordance with various embodiments of the disclosure;

FIG. 11 is a flowchart showing a process for determining a roaming timeout based on a target access point load in accordance with various embodiments of the disclosure;

FIG. 12 is a flowchart showing a process for overriding a baseline roaming timeout in accordance with various embodiments of the disclosure;

FIG. 13 is a flowchart showing a process for broadcasting a baseline roaming timeout in accordance with various embodiments of the disclosure;

FIG. 14 is a flowchart showing a process for determining a roaming timeout based on network congestion in accordance with various embodiments of the disclosure; and

FIG. 15 is a conceptual block diagram for one or more devices capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DESCRIPTION OF EXAMPLE EMBODIMENTS

### OVERVIEW

In some embodiments, a client device includes a processor, at least one wireless transceiver, and a memory communicatively coupled to the processor, wherein the memory includes a roaming management logic. The logic is configured to transmit a roaming preparation request to a target access point, receive a signaling frame containing a roaming timeout, prepare the target access point for a roaming transition, and perform a roaming execution to the target access point prior to expiration of the roaming timeout.

In some embodiments, a method of seamless network roaming includes receiving a roaming preparation request from a client device, determining a roaming timeout for the client device, generating a signaling frame containing the roaming timeout, and transmitting the signaling frame to the client device.

### EXAMPLE EMBODIMENTS

In response to the problems and issues described herein, embodiments of the present disclosure may provide systems and methods for roaming execution deadline signaling for seamless roaming. As network environments expand to support vast numbers of mobile clients, the need to optimize resource utilization during mobility events might become increasingly useful. When a client device prepares to transition to a new access point, the target node may reserve essential network resources, such as communication links and context data buffers, to ensure a seamless handover. However, if the client device were to delay the actual roaming execution indefinitely, these reserved resources could remain idle and unavailable to other active users, thereby degrading overall network capacity. Consequently, there may be a pressing need for a structured mechanism to dictate exactly how long a target access point might hold these reservations before discarding the roaming preparation state.

To address these challenges, the present disclosure may introduce various signaling options for indicating a roaming timeout to a client device. This deadline interval can represent a specific temporal constraint within which the client device may be expected to finalize a physical transition after initiating a roaming preparation. By explicitly communicating this time limit, a network infrastructure may accurately balance the competing demands of providing seamless mobility and maintaining optimal airtime efficiency. When a client device receives this signaled constraint, the client device might configure its internal protocol timers to ensure that a roaming execution phase may be completed prior to the expiration of the deadline. If the client device were to fail to transition in time, the target access point could safely delete the reserved preparation context, thereby freeing up the resources for other devices that might be operating within the seamless mobility domain.

In numerous embodiments, the network infrastructure could broadcast a baseline roaming timeout utilizing a seamless mobility domain information element. This approach might allow an access point multi-link device to distribute a domain-wide timing parameter to all prospective roaming clients that may be operating within a coverage area. For instance, the deadline interval may be incorporated into standard management frames, such as beacons or probe responses, which might ensure that devices seamlessly discover the constraints of the network before initiating any transition requests. The broadcasted interval could be structured using specific time units and varying byte lengths to provide network administrators with flexible control over the reservation duration. By relying on this globally advertised value, the network may establish a reliable baseline expectation for roaming behavior without typically necessitating complex, individual negotiations for every single mobile device.

In further embodiments, the network may provide the roaming timeout directly to a specific client device during an initial association procedure. Rather than relying solely on globally broadcasted values, an access point might leverage an existing timeout interval element to deliver a targeted deadline. This element could be embedded within an authentication frame or a reassociation response frame when the client might first connect to the overarching mobility domain. The client device might then override any baseline parameters the client device previously heard with this device-specific constraint. This targeted signaling technique may enable the network to enforce stricter or more relaxed mobility rules based on the specific capabilities or service level agreements that could be associated with individual client devices.

In additional embodiments, the roaming timeout might be dynamically provided directly within a roaming preparation response frame. This method could offer granular control, which may allow a target access point to calculate the deadline at the exact moment a roaming request might be received. If the target access point were to determine that a current network load might be light, the target access point may signal a longer deadline interval, granting the client device ample flexibility to finalize a handover. Conversely, if the target access point were to be heavily congested, the target access point could mandate a shorter deadline interval to quickly purge any stale reservations. Ultimately, this dynamic, load-aware signaling strategy might ensure that finite network resources may be dynamically protected and optimized while simultaneously maintaining a seamless user experience for actively transitioning devices.

Those skilled in the art will recognize that a seamless mobility domain can be a specialized wireless network architecture designed to facilitate uninterrupted connectivity for mobile devices. Within this architecture, a multitude of individual access points may be grouped together under a single, unified administrative and security umbrella. When a client device initially connects to this environment, the client device might undergo a comprehensive authentication and association process just one time. As the device physically moves and transitions its connection between the various access points within the group, it may not need to repeatedly re-authenticate or regenerate new cryptographic keys. Instead, the network infrastructure could share the established security context, such as a pairwise transient key, across the different nodes to maintain trust.

This shared security and administrative context might enhance the user experience by substantially reducing the latency typically associated with moving between standard wireless coverage areas. By bypassing the repetitive authentication handshakes, the overall transition time required for a device to switch its active connection may be drastically reduced. Furthermore, the persistent sharing of operational data between the network nodes can allow active communication sessions, such as voice calls or video streams, to proceed without noticeable interruption or buffering. Consequently, a seamless mobility domain could be particularly advantageous in large enterprise deployments, such as corporate campuses or hospitals, where dozens or even hundreds of access points might be required to provide comprehensive coverage.

Often a roaming process can be understood as a multi-phased mobility event comprising a distinct preparation phase and a subsequent execution phase. During the initial preparation phase, a client device might communicate with one or more potential target access points well in advance of actually moving its data connection. This early interaction may allow the client and the target infrastructure to pre-negotiate operational parameters, set up necessary communication links, and reserve vital airtime resources. Crucially, this advanced preparation can occur in the background while the client device maintains its active, uninterrupted data connection with its current access point. By handling these administrative overhead tasks preemptively, the network might prepare a soft landing spot for the device before the physical radio signal of the current connection begins to degrade.

Following the successful completion of the preparation steps, the client device may eventually initiate the roaming execution phase. This execution phase could represent the precise moment when the client severs its active data transmission with the old access point and formally shifts its communications to the newly prepared target node. During this rapid transition, dynamic context variables that are constantly changing, such as packet sequence numbers, might be finalized and transferred to ensure no data is lost in transit. Additionally, the broader network infrastructure may update its internal distribution system mapping so that incoming data packets from the internet are correctly routed to the client’s new physical location. To reduce the target node from holding reserved resources indefinitely, the client device must typically complete this execution phase before a strict deadline interval expires. If the execution does not occur before this deadline, the network may delete the roaming preparation from the target access point.

In various embodiments, a time unit can represent a standardized metric utilized within wireless networking protocols to measure and coordinate temporal events. A single time unit is generally defined by industry standards as being exactly one thousand and twenty-four microseconds, which makes it approximately equal to one standard millisecond. Network engineers and equipment manufacturers may frequently rely on these specific time units to define operational constraints, such as sleep intervals, beacon transmission rates, and resource reservation deadlines. By establishing a uniform temporal language, diverse devices from different vendors might accurately synchronize their internal clocks and coordinate complex interactions across the shared wireless medium. If the units were not strictly standardized, the delicate timing required to maintain seamless mobility could easily fall out of alignment, resulting in dropped packets and disconnected sessions.

The specific granularity of the time units employed by a network feature could play a role in balancing flexibility against computational overhead. Granularity generally refers to the smallest possible increment of time that an access point might utilize when configuring a specific parameter, such as how long it will keep a roaming preparation valid. If a network protocol dictates a very fine granularity, such as a single microsecond, the infrastructure could assert incredibly precise control over its resource reservations, but it might require transmitting larger data payloads to express those values. Conversely, utilizing a coarser granularity based on multiples of standard time units may allow the network to broadcast timing deadlines utilizing much smaller, more efficient data fields. For instance, an access point might set a timeout interval utilizing a base multiplier of sixty-four time units, which could provide a sufficiently balanced duration to manage roaming clients without unnecessarily inflating the size of the management frames.

Aspects of the present disclosure may be embodied as an apparatus, a system, a method, or a computer program product. Accordingly, aspects of the present disclosure may take the form of an entirely hardware embodiment, inserted into a prior deployment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. The executables of an identified function need not be physically located together but may comprise disparate instructions stored in different locations which, when joined logically together, comprise the function and achieve the stated purpose for the function.

A function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user’s computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages, or the like) or other discrete electrical devices, in electrical communication with one or more other components through electrical lines of a Printed Circuit Board (PCB) or the like. Each of the functions and/or modules described herein, in numerous additional embodiments, may alternatively be embodied by or implemented as a component.

A circuit, as used herein, comprises a set of one or more electrical and/or electronic components providing one or more pathways for electric current. In still yet further embodiments, a circuit may include a return pathway for electric current, so that the circuit is a closed loop. In still yet additional embodiments, however, a set of components that does not include a return pathway for electric current may be referred to as a circuit (e.g., an open loop). For example, an integrated circuit may be referred to as a circuit regardless of whether the integrated circuit is coupled to ground as a return pathway for electric current or not. In several embodiments, a circuit may include a portion of an integrated circuit, an integrated circuit, a set of integrated circuits, a set of non-integrated electrical and/or electrical components with or without integrated circuit devices, or the like. In several more embodiments, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages, or the like) or other discrete electrical devices, in electrical communication with one or more other components through electrical lines of a PCB or the like. Each of the functions and/or modules described herein, in various embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

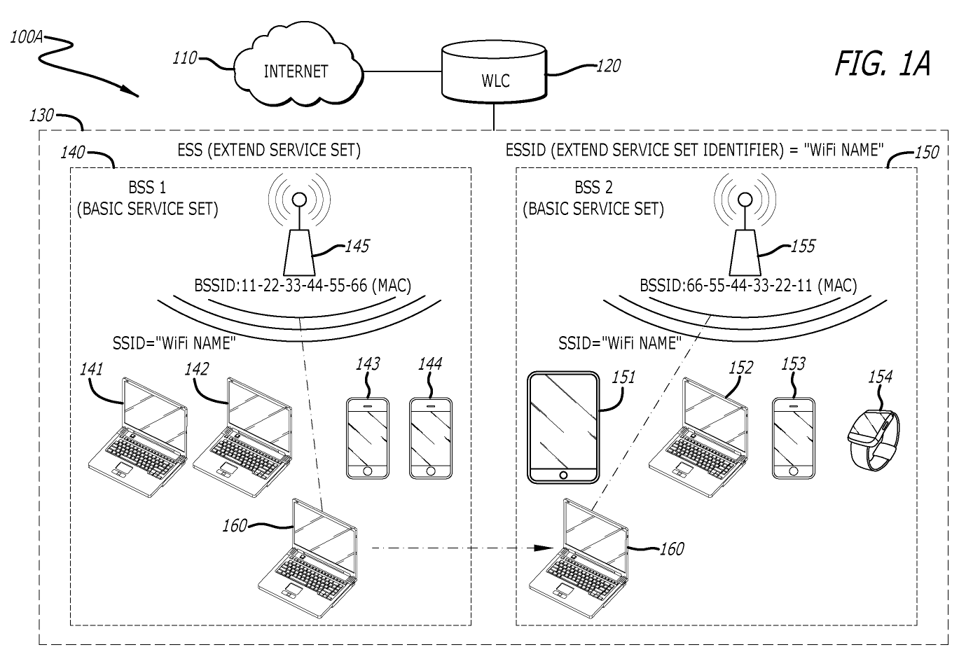

Referring to FIG. 1A, a schematic diagram of a network environment illustrating a client device roaming between access points in accordance with an embodiment of the disclosure is shown. In various embodiments, a network environment 100 can facilitate wireless communication among a plurality of connected devices. The network environment 100 may represent an enterprise deployment where extensive wireless coverage might be required to accommodate numerous mobile users. Within the network environment 100, seamless roaming techniques might be implemented to allow devices to transition smoothly without additional service interruptions. Furthermore, the network environment 100 could incorporate sophisticated protocols to handle complex resource management tasks associated with wireless connectivity.

In some embodiments, the network environment 100 can be communicatively coupled to an internet 110. The internet 110 might serve as a broad wide area network infrastructure that can route traffic to and from external servers or services. Access to the internet 110 may be essential for the various client devices that might seek to download data, stream media, or communicate with remote applications. Additionally, the internet 110 could provide the necessary backhaul connectivity required to support the extensive data demands of a modern enterprise wireless setup.

In certain embodiments, a wireless controller 120 can be deployed to manage and coordinate multiple access points within the network environment 100. The wireless controller 120 may orchestrate network-wide policies, handle authentication processes, and monitor the overall health of the wireless network infrastructure. Furthermore, the wireless controller 120 could assist in managing the distribution system mapping as client devices move and change their points of attachment. By centralizing these control functions, the wireless controller 120 might reduce the administrative overhead required to maintain persistent connectivity.

In many embodiments, an extended service set 130 can define a larger cohesive wireless coverage area created by linking multiple basic service sets. The extended service set 130 may act similarly to a seamless mobility domain, wherein a client device might associate once and then roam freely among the constituent access points without needing to completely re-associate or re-authenticate. Operating within the extended service set 130 could reduce roaming transition times by allowing context transfers between nodes. Consequently, the extended service set 130 might provide a unified network presence, often identified by a single network name or identifier across a wide physical area.

In further embodiments, a first basic service set 140 can represent a foundational building block of the wireless network. The first basic service set 140 might encompass the specific physical coverage area provided by a single wireless access node. Devices located within the first basic service set 140 can communicate through a shared wireless medium managed by that central node. The first basic service set 140 may also handle local resource allocation and interference mitigation for the devices currently connected within its boundaries.

In additional embodiments, a first laptop 141 can be positioned within the boundaries of the first basic service set 140. The first laptop 141 may function as a non-access point multi-link device capable of establishing sophisticated wireless connections. To maintain optimal performance, the first laptop 141 might persistently monitor signal strengths and network loads associated with its current connection. Additionally, the first laptop 141 could participate in dynamic context transfers if it were to initiate a mobility procedure.

In some embodiments, a second laptop 142 can also operate within the first basic service set 140. The second laptop 142 might share the wireless medium with other devices, necessitating efficient airtime management by the network infrastructure. Like other client devices, the second laptop 142 could leverage advanced wireless standards to execute high-throughput data transmissions. Furthermore, the second laptop 142 may be configured to interpret specialized signaling frames that dictate network deadlines and resource availability.

In certain embodiments, a first smartphone 143 can be connected to the network within the first basic service set 140. The first smartphone 143 might represent a highly mobile device that frequently requires robust roaming capabilities as a user carries it through a building. To preserve battery life and ensure smooth application performance, the first smartphone 143 could engage in preparation phases before executing a full network transition. The first smartphone 143 may rely on seamless mobility protocols to keep its active audio or video sessions uninterrupted.

In many embodiments, a second smartphone 144 can be similarly situated within the first basic service set 140. The second smartphone 144 might generate varying levels of network traffic depending on the specific applications being actively utilized by a user. As network congestion fluctuates, the second smartphone 144 could receive dynamically adjusted roaming timeouts from the infrastructure. By adhering to these signaled deadlines, the second smartphone 144 may help the network optimize resource reservations and reduce overall capacity degradation.

In various embodiments, a first access point 145 can serve as the central coordinating node for the first basic service set 140. The first access point 145 may broadcast a specific network identifier and a unique hardware address to facilitate device connections. As an access point multi-link device, the first access point 145 could manage multiple concurrent communication links with its associated clients. Moreover, the first access point 145 might communicate with neighboring nodes to negotiate context transfers and prepare for incoming or outgoing roaming devices.

In some embodiments, a second basic service set 150 can provide an adjacent or overlapping area of wireless coverage. The second basic service set 150 might share the same extended service set identifier as the first basic service set 140 to promote a unified user experience. Devices moving into the second basic service set 150 can undergo a transition execution phase to finalize their new connection. The second basic service set 150 may also evaluate its own current load to determine how long it can hold resources for incoming devices.

In further embodiments, a tablet 151 can be actively communicating within the second basic service set 150. The tablet 151 might consume additional network bandwidth if streaming high-definition media or participating in video conferences. To manage such demands, the network infrastructure could instruct the tablet 151 on specific timing requirements for any future mobility actions. The tablet 151 may parse management frames to discover nearby network neighbors and assess alternative connection options.

In additional embodiments, a third laptop 152 can be connected to the infrastructure via the second basic service set 150. The third laptop 152 could utilize seamless mobility domain features to maintain a shared temporal key during its operational session. If the third laptop 152 were to prepare for a roam, it might receive a timeout interval element indicating exactly how long its preparation remains valid. The third laptop 152 may then ensure it completes the transition before the expiration of that specific interval to avoid dropped connections.

In numerous embodiments, a third smartphone 153 can be located in the second basic service set 150. The third smartphone 153 might represent a device with strict latency requirements for voice-over-IP applications. To satisfy these requirements, the third smartphone 153 could benefit from rapid context transfers that eliminate the need for complete re-authentication. The network might temporarily provide the third smartphone 153 with a longer roaming timeout if the local access point is currently lightly loaded.

In some embodiments, a smartwatch 154 can also operate within the second basic service set 150. The smartwatch 154 may have limited processing power and battery capacity compared to larger computing devices. Consequently, the smartwatch 154 might heavily rely on the network infrastructure to optimize its connection and reduce the overhead associated with roaming. By participating in an advanced mobility domain, the smartwatch 154 could seamlessly maintain its background synchronization tasks as a user moves about the environment.

In certain embodiments, a second access point 155 can anchor the communications for the second basic service set 150. The second access point 155 may act as a target node for devices moving away from other nearby coverage areas. When receiving a preparation request, the second access point 155 could reserve specific resources and determine an appropriate execution deadline based on its own resource availability. Furthermore, the second access point 155 might transmit this dynamically determined deadline back to the requesting client device to enforce proper network timing.

In various embodiments, a roaming laptop 160 can physically transition between different physical locations within the overall infrastructure. The roaming laptop 160 might initiate a preparation phase to set up a new link before severing its existing connection. Following the preparation, the roaming laptop 160 could perform an execution phase to officially transfer its data context and distribution system mapping. The roaming laptop 160 may carefully monitor signaled deadlines to ensure this execution phase is completed before the target node deletes the reserved state.

In a non-limiting example, the components of the network environment 100 can interact to facilitate a seamless transition for a mobile user. The roaming laptop 160 might initially be connected to the first access point 145 but detect a deteriorating signal as it moves. To ensure persistent service, the roaming laptop 160 could send a preparation request to the second access point 155. The second access point 155 may then reserve necessary resources and provide a specific timeout interval to the roaming laptop 160. Subsequently, the roaming laptop 160 might execute the roam to the second access point 155 before the timeout interval expires, thereby avoiding any noticeable disruption in connectivity.

For instance, the network environment 100 may dynamically adapt to changing traffic conditions to optimize overall efficiency. If the first access point 145 becomes heavily congested due to high data usage from the first laptop 141 and the second laptop 142, it might need to conserve its available resources. When the first smartphone 143 attempts to prepare a roam to the first access point 145 from another location, the first access point 145 could respond with a shorter roaming timeout. This shorter deadline may force the first smartphone 143 to transition quickly or forfeit the reservation, ensuring the first access point 145 does not hold idle resources for extended periods during peak usage. Conversely, if the second access point 155 is lightly loaded, it might grant a longer deadline to incoming devices, offering them more flexibility.

It is contemplated that the wireless controller 120 can play a role in managing the broader mobility domain represented by the extended service set 130. As the roaming laptop 160 transitions from the first basic service set 140 to the second basic service set 150, dynamic context such as packet numbers might need to be transferred. The first access point 145 and the second access point 155 could communicate over a backhaul network to securely exchange this context without typically necessitating the roaming laptop 160 to regenerate cryptographic keys. The wireless controller 120 may oversee this process to ensure that the distribution system mapping is properly updated so that data packets originating from the internet 110 are accurately routed to the roaming laptop 160 at its new location. This coordinated approach might drastically reduce overhead and ensure a high-quality user experience across the extended service set 130 entirely.

Although a specific embodiment for a network environment 100 for carrying out the various steps, processes, methods, and operations described herein is discussed with respect to FIG. 1A, any of a variety of systems and/or devices may be utilized in accordance with embodiments of the disclosure. For example, the network environment 100 might encompass additional access points, entirely different types of client devices, or operate over different wired and wireless protocols. The elements depicted in FIG. 1A may also be interchangeable with other elements of FIGS. 1B–15 as required to realize a particularly desired embodiment.

Referring to FIG. 1B, a schematic diagram of a seamless mobility domain environment, in accordance with various embodiments of the disclosure is shown. In many embodiments, a seamless mobility domain environment 100B can comprise a seamless mobility domain (SMD 101) that may consist of multiple access point multi-link devices and a management entity (SMD-ME) operating within the seamless mobility domain environment 100B. The seamless mobility domain environment 100B might facilitate seamless transitions for client devices roaming across different coverage areas. Additionally, the seamless mobility domain environment 100B could coordinate network resource allocations to ensure persistent connectivity without additional service interruptions.

In some embodiments, a network controller 102 can be deployed within the seamless mobility domain environment 100B. The network controller 102 may operate as a seamless mobility domain management entity to oversee and coordinate operations among various network nodes. Furthermore, the network controller 102 might facilitate a domain-level association when a client device initially connects to the infrastructure. By centralizing these control functions, the network controller 102 could reduce the administrative overhead required to maintain persistent wireless access.

In various embodiments, a non-access point multi-link device 106 can operate within the seamless mobility domain environment 100B. The non-access point multi-link device 106 may function as a client computing device that consumes network resources and associates with the network controller 102 to set up the domain-level association. To maintain persistent connectivity, the non-access point multi-link device 106 could perform seamless mobility domain roaming, which may also be referred to as a basic service set transition, as it physically moves through the coverage areas. Moreover, the non-access point multi-link device 106 might persistently monitor signal strengths and evaluate alternative connection options.

In certain embodiments, a first access point multi-link device 104 can provide a first area of wireless coverage within the seamless mobility domain environment 100B. The first access point multi-link device 104 might serve as a current point of attachment for the non-access point multi-link device 106. The first access point multi-link device 104 may be configured to manage multiple simultaneous communication links with associated client devices to improve data throughput and reliability. Additionally, the first access point multi-link device 104 could communicate with neighboring access points to negotiate context transfers.

In additional embodiments, a second access point multi-link device 105 can provide a second area of wireless coverage adjacent to the first access point multi-link device 104. The second access point multi-link device 105 could act as a target node for incoming roaming devices moving away from other nearby coverage areas. The second access point multi-link device 105 may evaluate its available network resources to determine how long it can reserve capacity for a device that might be preparing to transition. Furthermore, the second access point multi-link device 105 might transmit dynamically determined deadlines back to requesting client devices to enforce proper network timing.

In many embodiments, the elements of the seamless mobility domain environment 100B can interact to execute a roaming preparation phase. For instance, the non-access point multi-link device 106 may initiate a roaming preparation for the second access point multi-link device 105 while still connected to the first access point multi-link device 104. This roaming preparation could involve setting up necessary communication links, executing a context transfer, and reserving network resources at the second access point multi-link device 105 specifically for the non-access point multi-link device 106. Such preparation phases might reduce data loss and reduce latency during the actual transition process.

In further embodiments, the seamless mobility domain environment 100B can define and enforce a roaming preparation timeout to effectively manage the reserved resources. The roaming preparation timeout, which might also be referred to as a roaming timeout interval or a roaming timeout, can indicate an amount of time for which the roaming preparation remains valid at the second access point multi-link device 105. By establishing this duration, the network controller 102 or the second access point multi-link device 105 may ensure that resources are not held indefinitely for a transition that may be delayed. The non-access point multi-link device 106 could parse management frames to receive and process this timeout interval.

In some embodiments, the non-access point multi-link device 106 can complete the transition by performing a roaming execution phase. The non-access point multi-link device 106 might need to perform the roaming execution within the duration of the roaming preparation timeout for the roaming execution to be considered valid by the second access point multi-link device 105. If the second access point multi-link device 105 receives the roaming execution after the roaming preparation timeout has elapsed, the roaming preparation may be deemed to have expired. Consequently, the roaming execution might be rejected or otherwise not responded to by the second access point multi-link device 105, thereby allowing the network to reclaim the previously reserved capacity.

Although a specific embodiment for a seamless mobility domain environment for carrying out the various steps, processes, methods, and operations described herein is discussed with respect to FIG. 1B, any of a variety of systems and/or devices may be utilized in accordance with embodiments of the disclosure. For example, the seamless mobility domain environment 100B may encompass additional access point multi-link devices or manage transitions utilizing alternative timeout signaling mechanisms. The elements depicted in FIG. 1B may also be interchangeable with other elements of FIGS. 1A and 2–15 as required to realize a particularly desired embodiment.

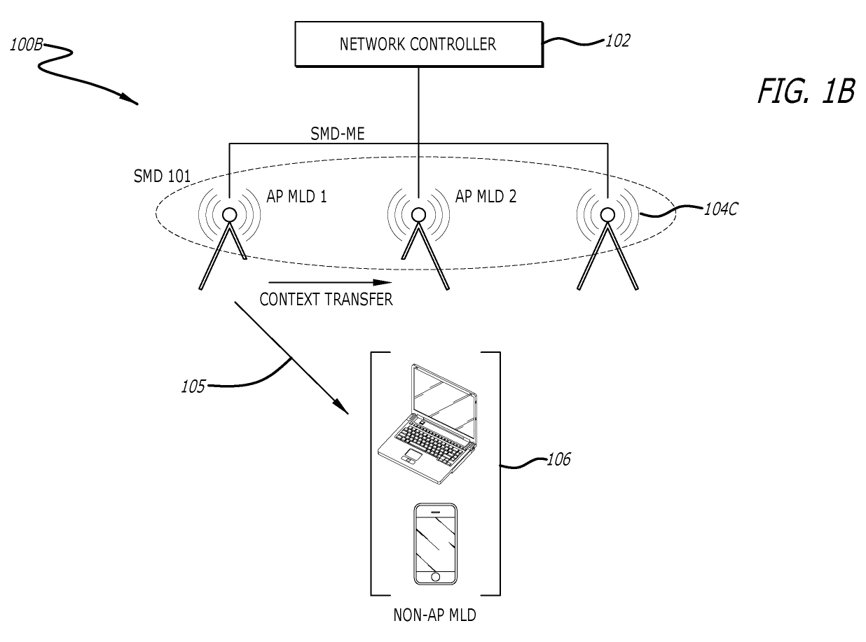

Referring to FIG. 2, a diagram illustrating an Open Systems Interconnection (OSI) model in accordance with various embodiments of the disclosure is shown. In various embodiments, an OSI model 200 can provide a conceptual framework for understanding how different networking protocols interact to facilitate communication. The OSI model 200 might separate the complex processes of network communication into distinct, manageable functional layers. By utilizing the OSI model 200, network engineers and developers could troubleshoot issues by isolating problems to specific functional areas. Furthermore, the OSI model 200 may serve as a standard reference to ensure interoperability between diverse hardware and software systems across a wireless mobility domain.

In many embodiments, an application layer 254 can represent the uppermost level of the OSI model 200 where network applications interact directly with software programs. The application layer 254 might process user requests and provide services such as file transfers, email, and web browsing. When a client device initiates a roaming preparation request, the application layer 254 could be responsible for generating the initial data payload associated with that specific application’s needs. Additionally, the application layer 254 may interface with underlying communication sub-systems to ensure that data is correctly formatted before being passed down the stack.

In some embodiments, a presentation layer 256 can operate below the application layer 254 to prepare data for transmission or consumption. The presentation layer 256 might handle tasks such as data encryption, decryption, compression, and translation to ensure compatibility between different systems. During a seamless roaming event, the presentation layer 256 could ensure that any secure context being transferred maintains its encrypted state. Moreover, the presentation layer 256 may abstract the differences in data representation formats so that the application layer 254 does not need to handle these complexities.

In further embodiments, a session layer 258 can establish, manage, and terminate connections between local and remote applications. The session layer 258 might be useful for maintaining persistent dialogs or sessions as a mobile device transitions between different access points. If a connection is temporarily lost during a roaming execution phase, the session layer 258 could facilitate the resumption of the session without typically necessitating the user to restart the application. Consequently, the session layer 258 may coordinate communication synchronization points to ensure that data streams remain coherent and synchronized across the network.

In additional embodiments, a transport layer 260 can provide reliable or unreliable data transfer services depending on the specific requirements of the underlying application. The transport layer 260 might utilize protocols to manage packet sequencing, error recovery, and flow control. As dynamic context such as packet numbers and sequence numbers are transferred during a roam, the transport layer 260 could be responsible for keeping these numbers aligned to reduce data loss. The transport layer 260 may also segment large data messages into smaller packets suitable for transmission over the wireless medium.

In certain embodiments, a network layer 262 can manage the routing of data packets from a source device to a destination device across multiple interconnected networks. The network layer 262 might assign logical addresses to ensure that packets reach their intended targets reliably. When a client device changes its point of attachment during a seamless roam, the network layer 262 could interact with the distribution system mapping to update routing paths. Furthermore, the network layer 262 may determine the optimal path for data packets based on current network loads and routing metrics.

In numerous embodiments, a data link layer 264 can provide node-to-node data transfer capabilities and handle error correction for physical transmission issues. The data link layer 264 might manage hardware addresses, which are heavily utilized when a client device associates with a new access point multi-link device. During the roaming preparation phase, the data link layer 264 could be intimately involved in setting up new links and reserving necessary airtime resources. Additionally, the data link layer 264 may process the specialized signaling frames that contain the roaming timeout.

In various embodiments, a physical layer 266 can represent the lowest level of the OSI model 200, responsible for the actual transmission and reception of raw bit streams over a physical medium. The physical layer 266 might govern the radio frequency characteristics, modulation schemes, and antenna configurations used in wireless communications. When a device measures received signal strengths to evaluate potential target access points, those measurements could originate from the physical layer 266. Furthermore, the physical layer 266 may execute the final step of wirelessly broadcasting the bits that comprise a timeout interval element to a roaming client device.

In a non-limiting example, the various layers of the OSI model 200 can collaborate to facilitate the seamless roaming of a client device. When a smartphone initiates a video call, the application layer 254 might capture the video data and pass it down the stack. The presentation layer 256 could compress this video stream, while the session layer 258 may establish a persistent communication dialog with a remote server. The transport layer 260 might segment the video data, and the network layer 262 could route these segments toward the current access point. As the smartphone prepares to roam, the data link layer 264 may receive a management frame containing a specific deadline interval, which the physical layer 266 physically captures from the wireless radio waves.

For instance, the OSI model 200 might dictate how dynamic context is preserved during a network transition to reduce service disruption. As a laptop moves toward a new access point, the data link layer 264 could negotiate a new link setup and reserve necessary block acknowledgment resources. Concurrently, the transport layer 260 may freeze its current sequence numbers to prepare for the dynamic context transfer. The network layer 262 might update the distribution system mapping to reflect the laptop’s new location. Through this coordinated effort across the data link layer 264, the network layer 262, and the transport layer 260, the overall transition could be completed efficiently before the signaled execution deadline expires.

It is contemplated that the OSI model 200 can provide a structural framework for implementing new network signaling mechanisms, such as a roaming timeout. A wireless controller could generate a timeout interval element at the application layer 254 of its management software. This configuration data might be passed down through the transport layer 260 and the network layer 262 to reach a specific access point multi-link device. At the access point, the data link layer 264 could encapsulate this interval into a specific signaling frame, such as a beacon or roaming preparation response. Finally, the physical layer 266 may broadcast the frame to all nearby client devices, allowing their respective communication stacks to parse the deadline and adjust their roaming behavior accordingly.

Although a specific embodiment for an OSI model 200 for carrying out the various steps, processes, methods, and operations described herein is discussed with respect to FIG. 2, any of a variety of systems and/or devices may be utilized in accordance with embodiments of the disclosure. For example, alternative networking models, such as a four-layer protocol suite, could be utilized to conceptualize and manage the network communications. The elements depicted in FIG. 2 may also be interchangeable with other elements of FIGS. 1 and 3–15 as required to realize a particularly desired embodiment.

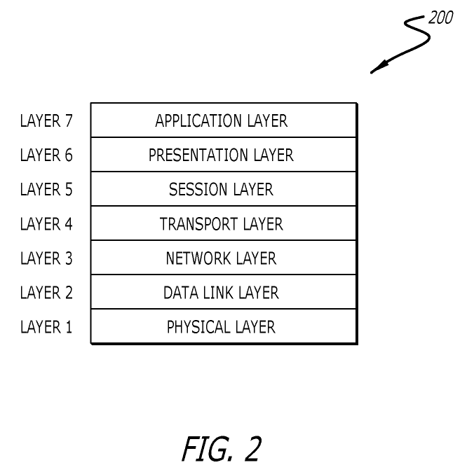

Referring to FIG. 3, a diagram illustrating a client device roaming between overlapping coverage areas of multiple access points in accordance with an embodiment of the disclosure is shown. In various embodiments, a network environment 300 can represent a wireless deployment where multiple communication nodes provide overlapping radio frequency coverage. The network environment 300 might facilitate persistent connectivity for mobile users navigating through a physical space. By leveraging advanced mobility protocols, the network environment 300 could enable devices to seamlessly transition between different service areas without experiencing perceptible drops in data transmission. Furthermore, the network environment 300 may support sophisticated signaling mechanisms to effectively manage network resources during these roaming transitions.

In many embodiments, a first access point 310 can be deployed within the network environment 300 to establish a primary wireless coverage zone. The first access point 310 might broadcast signals that attenuate over distance, creating varying signal strength boundaries such as a negative thirty decibel-milliwatts boundary, a negative fifty decibel-milliwatts boundary, and a negative seventy decibel-milliwatts boundary. As a component of a larger seamless mobility domain, the first access point 310 could serve as a current point of attachment for actively communicating devices. Additionally, the first access point 310 may monitor its own internal resource load to dynamically determine how it should handle incoming roaming requests or outgoing context transfers.

In some embodiments, a second access point 320 can provide an adjacent coverage area that overlaps with the boundaries of the first access point 310. The second access point 320 might also exhibit specific signal strength contours, including a negative thirty decibel-milliwatts region, a negative fifty decibel-milliwatts region, and an outer negative eighty decibel-milliwatts region. During a mobility event, the second access point 320 could act as a target node that receives a roaming preparation request from a neighboring device. In response to such a request, the second access point 320 may reserve communication links and transmit a roaming timeout to dictate exactly how long those resources will be held.

In further embodiments, a client device 350 can physically traverse the space between the first access point 310 and the second access point 320. The client device 350 might represent a mobile phone, a laptop, or any other non-access point multi-link device that requires uninterrupted wireless service. To determine the optimal time to initiate a network transition, the client device 350 could persistently perform received signal strength indicator measurements of neighboring nodes. Upon identifying a favorable target, the client device 350 may parse management frames to receive a specific timeout interval element that governs the allowable timeframe for completing its roaming execution.

In a non-limiting example, the components depicted within the network environment 300 can collaborate to maintain an active communication session. The client device 350 might initially be connected to the first access point 310 and experience a strong signal near the negative thirty decibel-milliwatts range. As the client device 350 moves away, the signal may degrade to the negative seventy decibel-milliwatts boundary, prompting the client device 350 to evaluate the second access point 320. The client device 350 could then transmit a roaming preparation request to the second access point 320 to begin setting up new communication links. Subsequently, the second access point 320 might respond with a signaling frame containing a baseline roaming timeout that the client device 350 must obey to successfully finalize the transition.

For instance, the network environment 300 may need to dynamically adjust its parameters based on real-time traffic conditions. If the second access point 320 is currently experiencing heavy network congestion, it might not be able to reserve context transfer resources for an extended duration. When the client device 350 requests to prepare for a roam, the second access point 320 could evaluate this high load and deliberately provide a shorter roaming timeout. The client device 350 may then be forced to complete its roaming execution to the second access point 320 very quickly. If the client device 350 fails to execute the transition before this shortened deadline expires, the second access point 320 might delete the reserved preparation state to free up the valuable network resources for other users.

It is contemplated that the first access point 310 and the second access point 320 can both belong to a single seamless mobility domain to further enhance the overall user experience. By sharing a mobility domain, the client device 350 might associate once with the network and subsequently roam without needing to regenerate security keys or perform full re-authentications. As the client device 350 transitions to the second access point 320, dynamic context such as packet numbers could be seamlessly transferred across the backhaul infrastructure. The second access point 320 may override a globally advertised timeout value with a specific, longer roaming timeout if it is lightly loaded, giving the client device 350 maximum flexibility. Ultimately, this coordinated effort across the network environment 300 might ensure that the client device 350 maintains a flawless connection while airtime resources are efficiently prioritized.

Although a specific embodiment for a network environment 300 for carrying out the various steps, processes, methods, and operations described herein is discussed with respect to FIG. 3, any of a variety of systems and/or devices may be utilized in accordance with embodiments of the disclosure. For example, the network environment 300 might include additional access points, highly varied coverage topologies, or employ alternative radio measurement techniques. The elements depicted in FIG. 3 may also be interchangeable with other elements of FIGS. 1–2 and 4–15 as required to realize a particularly desired embodiment.

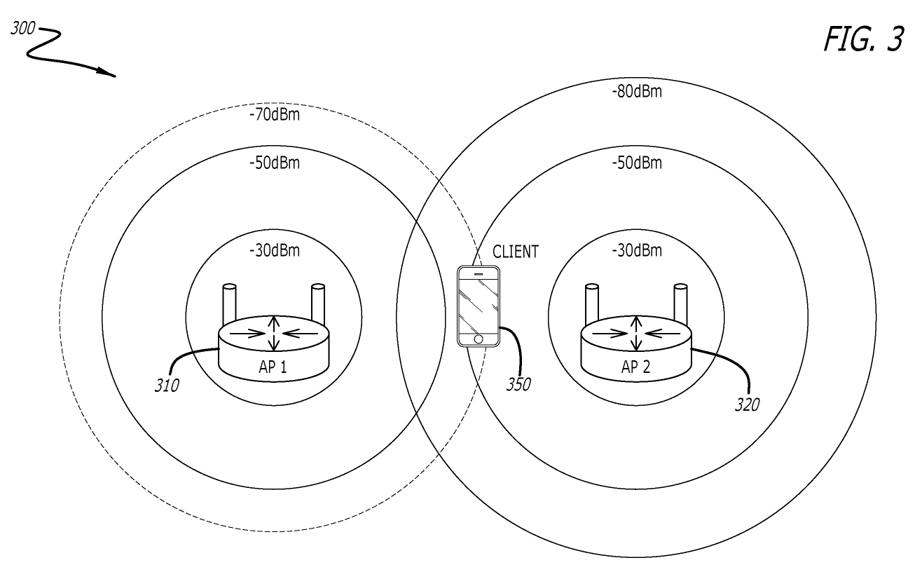

Referring to FIG. 4, a block diagram illustrating a seamless mobility domain element format in accordance with various embodiments of the disclosure is shown. In various embodiments, a seamless mobility domain element format 400 can define a structure for an information element broadcasted or transmitted by an access point multi-link device. The seamless mobility domain element format 400 might be utilized to disseminate network parameters that enable client devices to associate with and transition within a seamless mobility domain. By providing this structured data, the seamless mobility domain element format 400 could ensure that non-access point multi-link devices understand the capabilities and timing constraints of the network for SMD roaming. Furthermore, management frames such as beacons, probe responses, and fast initial link setup discovery, (re)association response frames may incorporate the seamless mobility domain element format 400 to broadcast these parameters across an entire coverage area.

In many embodiments, an element ID 410 can serve as the first field within the seamless mobility domain element format 400. The element ID 410 might be configured to occupy exactly one octet of data. A receiving device could parse the element ID 410 to identify the classification or general type of the information element being processed. Utilizing the element ID 410 can allow the network protocol stack to efficiently sort and route the encapsulated data to the appropriate processing logic within a client device.

In some embodiments, a length 420 can logically follow the element ID 410. The length 420 might also be strictly defined as a one-octet field. The network device generating the frame may use the length 420 to explicitly indicate the total size of the remaining fields within the element. By reading the length 420, a receiving parser could determine exactly how many subsequent bytes belong to this specific element, which might reduce buffer overruns and facilitate accurate decoding of variable-sized fields.

In further embodiments, an element ID extension 430 can be incorporated into the element. The element ID extension 430 might span a single octet of memory space. Because the standard element identifier space could become exhausted as new features are added to wireless protocols, the element ID extension 430 may provide additional addressable space to classify newer information elements. Consequently, the combination of the element ID 410 and the element ID extension 430 could uniquely identify the entire structure as representing a specific mobility domain parameter set.

In additional embodiments, a seamless mobility domain identifier 440 can provide a unique designation for the specific mobility domain. The seamless mobility domain identifier 440 might comprise six octets, which can often represent a forty-eight-bit media access control address associated with the entire seamless mobility domain.

In certain embodiments, a seamless mobility domain capabilities 450 can outline the specific technical features supported by the network. The seamless mobility domain capabilities 450 might have a specific length defined in the amendment (e.g. 1 or 2 or 3 or 4 octets), this is represented by an unspecified number of octets in 400. The access point may populate the seamless mobility domain capabilities 450 with flags and values that indicate capabilities supported for SMD roaming such as security mode used for roaming, data forwarding capability and other roaming configurations supported within the SMD. A client device parsing the seamless mobility domain capabilities 450 could utilize this information when performing seamless roaming within the SMD.

In numerous embodiments, a roaming timeout interval 460 can be appended to the structure to establish strict timing requirements for performing SMD roaming (or SMD BSS transition). The roaming timeout interval 460 might have a specific length defined, such as 1 or 2 octets, indicated by X octets, depending on the required granularity and the maximum supported timeout duration defined in the amendment. The network could use the roaming timeout interval 460 to signal a domain-wide value that dictates exactly how long a target access point will reserve resources after a roaming preparation request. The roaming timeout interval 460 may be expressed in defined units, such as multiples of a standard time unit (TU), to give the network control over how long resources are reserved for a roaming preparation within an SMD. The network keeps the resources reserved for a roaming preparation for the timeout value indicated by the roaming timeout interval 460. The client is expected to perform roaming execution within the timeout value indicated by the roaming timeout interval 460.

In a non-limiting example, the various fields of the seamless mobility domain element format 400 can work together to broadcast useful roaming parameters across a corporate campus. An enterprise access point might assemble the seamless mobility domain element format 400 inside its routine beacon transmissions to inform nearby laptops of its presence. The access point could set the seamless mobility domain identifier 440 to match the campus-wide media access control address, ensuring devices recognize the unified network. Concurrently, the access point may configure the roaming timeout interval 460 to a relatively short value within its X octets to reduce highly mobile devices from needlessly holding reserved links on multiple target nodes for extended periods. When a laptop parses the length 420 and extracts these values, it might adapt its roaming algorithms to execute SMD roaming transitions rapidly.

For instance, the seamless mobility domain element format 400 might be utilized during active network discovery when a smartphone sends out a probe request. A receiving access point could generate a probe response that includes the seamless mobility domain element format 400 to directly answer the smartphone’s inquiry. In this response, the element ID 410 and the element ID extension 430 may instantly flag the data block as seamless mobility domain information. By simultaneously extracting the variable-length X octets of the roaming timeout interval 460, the smartphone might calculate exactly how much time it has to finalize its connection before the access point drops the potential session.

Although a specific embodiment for a seamless mobility domain element format 400 for carrying out the various steps, processes, methods, and operations described herein is discussed with respect to FIG. 4, any of a variety of systems and/or devices may be utilized in accordance with embodiments of the disclosure. For example, the element might be arranged with fields in a different sequential order or include additional vendor-specific sub-elements. Furthermore, the overall byte size of the fields could be modified to support entirely new wireless protocols. The elements depicted in FIG. 4 may also be interchangeable with other elements of FIGS. 1–3 and 5–15 as required to realize a particularly desired embodiment.

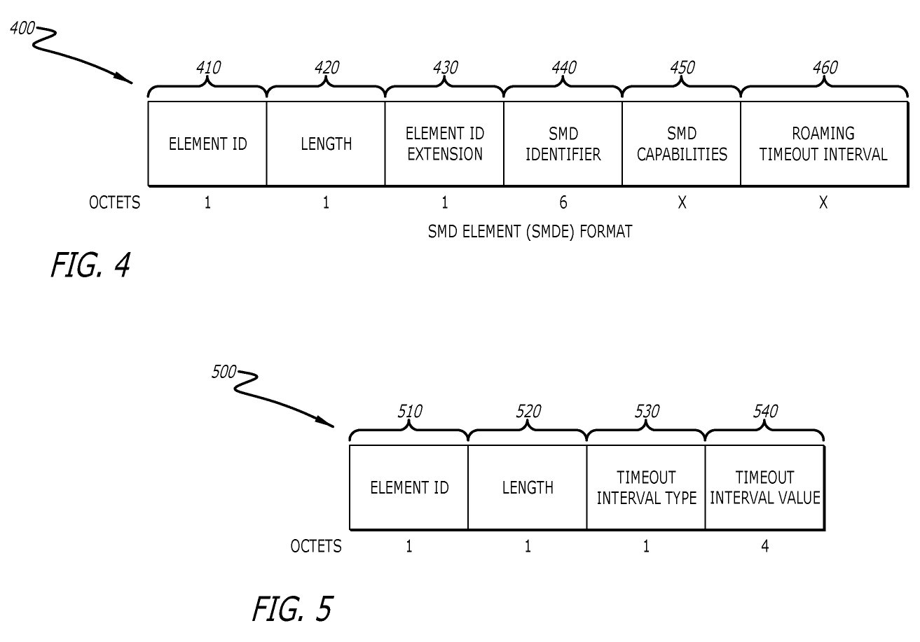

Referring to FIG. 5, a block diagram illustrating a timeout interval element format in accordance with various embodiments of the disclosure is shown. In various embodiments, a timeout interval element format 500 can define a structural arrangement for transmitting timing constraints between network devices. The timeout interval element format 500 might be utilized within management frames to communicate specific deadlines that client devices may be expected to adhere to during network operations. By employing the timeout interval element format 500, an access point may efficiently broadcast or unicast temporal parameters required for maintaining a seamless mobility domain. Furthermore, the timeout interval element format 500 could allow for the standardization of timing information across various wireless protocols and equipment vendors.

In many embodiments, an element ID 510 can be positioned as the initial field within the data structure. The element ID 510 might occupy a single octet of memory and can serve to classify the specific nature of the information being transmitted. When a receiving device parses the element ID 510, it could recognize that the subsequent data pertains to timeout intervals rather than other network parameters. Consequently, the element ID 510 may enable the protocol stack of a client device to quickly route the payload to the appropriate internal processing logic.

In some embodiments, a length 520 can logically follow the identifier field to specify the size of the remaining data. The length 520 might also be configured as a one-octet field that provides a numerical count of the subsequent bytes contained within the element. A network node receiving the length 520 could utilize this value to determine the exact boundary of the timeout information, which may reduce reading errors or buffer overflows. By explicitly defining the size using the length 520, the element can dynamically adapt to accommodate different data payloads if protocol extensions are added in the future.

In further embodiments, a timeout interval type 530 can be included to specify the exact category of the timing constraint being provided. The timeout interval type 530 might span one octet and can contain a specific numerical value corresponding to a predefined operational deadline. For example, the timeout interval type 530 could indicate that the associated value represents a roaming timeout or a reassociation deadline interval. A parsing device reading the timeout interval type 530 may then apply the corresponding timing rule to the correct network procedure, such as a mobility transition or a key lifecycle event.

In additional embodiments, a timeout interval value 540 can convey the actual numerical duration associated with the specified deadline. The timeout interval value 540 might be allocated four octets of space to accommodate a wide range of temporal granularities, from very brief microseconds to much longer multi-second durations. A target access point could populate the timeout interval value 540 with a specific quantity of time units based on its current resource load and network congestion. Upon receiving the timeout interval value 540, a mobile device may configure its internal timers to ensure it could execute required actions, such as roaming, before the specified duration expires.

In a non-limiting example, the components of the timeout interval element format 500 can operate in concert to manage a roaming preparation phase. A wireless access point might assemble a management frame that incorporates the timeout interval element format 500 to guide a transitioning smartphone. The access point could configure the element ID 510 to flag the data block and set the timeout interval type 530 to denote a roaming execution deadline. Concurrently, the access point may calculate a specific duration based on its available resources and encode this into the timeout interval value 540. Once the smartphone receives the frame, it might read the length 520 to extract the exact deadline and proceed to finalize its roam before the resources are released.

For instance, the timeout interval element format 500 might be utilized during an initial association procedure when a laptop connects to a seamless mobility domain. A network controller could transmit an authentication response utilizing the timeout interval element format 500 to establish baseline timing rules for the new client. The controller may populate the timeout interval type 530 with a value indicating a reassociation deadline and provide a corresponding four-octet number in the timeout interval value 540. The laptop could parse the element ID 510 to recognize the configuration data and use the length 520 to safely process the remaining fields. This coordinated data delivery may ensure the laptop understands the network’s timing expectations from the moment it joins the infrastructure.

It is contemplated that the timeout interval element format 500 can dynamically provide updated timing constraints during periods of heavy network congestion. If an access point becomes overloaded, it might need to shorten the time it holds resources for incoming roaming devices. The access point could generate a new message structured according to the timeout interval element format 500, ensuring the element ID 510 and the length 520 are correctly formatted for the transmission. The access point may then assign the timeout interval type 530 to indicate a roaming execution deadline and insert a substantially smaller number into the timeout interval value 540. A receiving tablet might interpret these interconnected fields to realize it may need to accelerate its roaming execution to secure the connection.

Although a specific embodiment for a timeout interval element format 500 for carrying out the various steps, processes, methods, and operations described herein is discussed with respect to FIG. 5, any of a variety of systems and/or devices may be utilized in accordance with embodiments of the disclosure. For example, the element might be arranged with fields in a different sequential order, or the specific octet lengths of the fields could be modified to support alternative networking standards. Additionally, the specific numerical values assigned to represent various timing constraints could be customized to fit specific hardware requirements. The elements depicted in FIG. 5 may also be interchangeable with other elements of FIGS. 1–4 and 6–15 as required to realize a particularly desired embodiment.

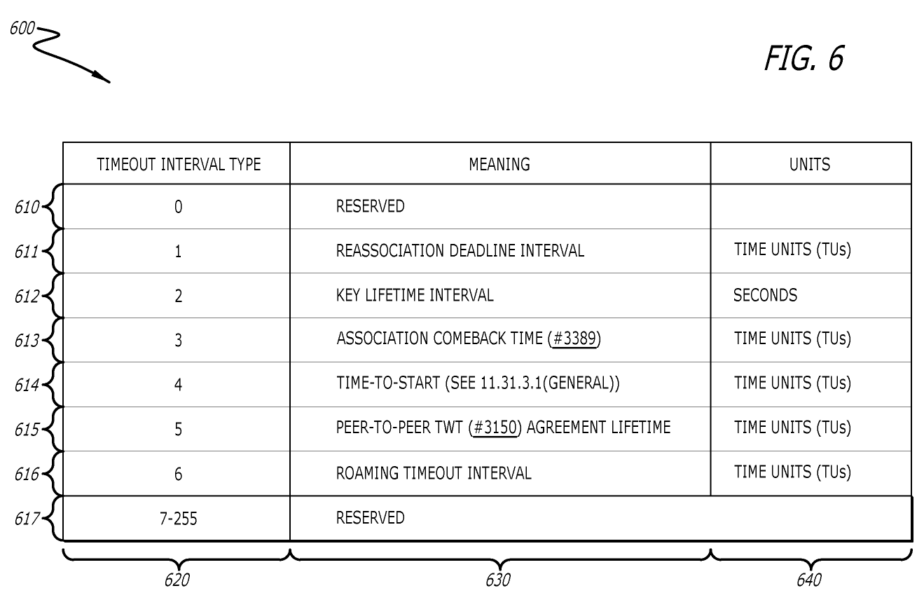

Referring to FIG. 6, a table illustrating timeout interval type field values in accordance with various embodiments of the disclosure is shown. In various embodiments, a timeout interval type table 600 can outline the specific numerical designations assigned to different timing constraints within a wireless network. The timeout interval type table 600 might serve as a reference for network devices to interpret the specific operational deadlines conveyed in management frames. By utilizing the structured data defined in the timeout interval type table 600, a protocol stack could accurately determine which internal timers to trigger upon receiving a signaling payload. Furthermore, the timeout interval type table 600 may provide a standardized mechanism to ensure interoperability among equipment from diverse manufacturers across a seamless mobility domain.

In many embodiments, a first column 620 can list the specific numerical values assigned to each distinct timeout category. The first column 620 might represent the data that would typically be populated within a dedicated type field of a transmitted information element. A network device could parse a received frame and match the extracted type value against the entries listed in the first column 620. By establishing these discrete numerical identifiers, the first column 620 may allow a client device to quickly and unambiguously recognize the nature of the timing constraint it is being instructed to follow.

In some embodiments, a second column 630 can provide the descriptive meaning or operational context for each corresponding numerical type. The second column 630 might define the specific network procedure or lifecycle event that the timeout interval governs. For example, the text within the second column 630 could instruct a device on whether a deadline relates to a security key expiration or a mobility transition. Consequently, the definitions organized in the second column 630 may dictate the exact hardware and software responses a receiving device should execute to maintain compliance with the network’s parameters.

In further embodiments, a third column 640 can establish the specific temporal units utilized to measure the associated timeout interval. The third column 640 might specify whether the duration is calculated in seconds, time units, or another granular measurement. An access point referencing the rules of the third column 640 could correctly format its requested deadline before broadcasting it to associated clients. By strictly defining these metrics, the third column 640 may ensure that both the transmitting node and the receiving node share an identical understanding of the time remaining before a deadline expires.

In additional embodiments, a first row 610 can correspond to a type value of zero, which may be designated as a reserved value. The first row 610 might hold this initial numerical index open for potential future protocol expansions or proprietary vendor extensions. A client device parsing a frame that correlates to the first row 610 could be programmed to ignore the field if it lacks the specific software update required to interpret the new feature. Thus, the reserved status indicated by the first row 610 may provide a safeguard against immediate obsolescence as wireless standards continue to evolve.

In certain embodiments, a second row 611 can define a type value of one, which corresponds to a reassociation deadline interval. The second row 611 might instruct a device on the maximum allowable time to complete a fast transition process after an initial authentication. The temporal metric for the second row 611 could be strictly defined in time units, allowing for precise control over the reassociation phase. A mobile station referencing the second row 611 may configure its internal transition timers to ensure it finalizes its new connection before the target access point discards the authentication state.

In numerous embodiments, a third row 612 can associate a type value of two with a key lifetime interval. The third row 612 might dictate the operational lifespan of cryptographic keys utilized to secure data transmissions across the wireless medium. In contrast to other entries, the temporal units specified in the third row 612 could be measured in full seconds, reflecting the generally longer duration of security associations. A wireless client processing a deadline based on the third row 612 may initiate a key renewal handshake well before the specified seconds elapse to reduce an abrupt termination of its secure session.

In various embodiments, a fourth row 613 can establish a type value of three for an association comeback time. The fourth row 613 might be utilized when an access point is temporarily overwhelmed and requests a client to delay its connection attempt. The duration for the fourth row 613 could be calculated in time units, providing a sufficiently granular delay to stagger incoming client requests. A device receiving a message formatted according to the fourth row 613 may enter a brief sleep state and awake only after the specified time units have passed to retry its association.

In some embodiments, a fifth row 614 can allocate a type value of four to represent a time-to-start parameter. The fifth row 614 might govern the initiation of specific scheduled access periods or targeted wake times for connected devices. Measured in time units, the duration associated with the fifth row 614 could allow an access point to finely coordinate when different clients awaken to exchange buffered data. A low-power sensor relying on the fifth row 614 may drastically reduce its energy consumption by synchronizing its radio activity substantially with the network’s planned schedule.

In further embodiments, a sixth row 615 can assign a type value of five to a peer-to-peer target wake time agreement lifetime. The sixth row 615 might define the maximum duration that two client devices can directly communicate under a negotiated power-saving schedule. The metric for the sixth row 615 could also be specified in time units to align with the standard timing mechanisms of the overarching network. A pair of smart devices utilizing the parameters of the sixth row 615 may frequently renegotiate their direct link before the lifetime expires to maintain an uninterrupted, power-efficient data exchange.

In additional embodiments, a seventh row 616 can define a type value of six, specifically designated for a roaming timeout. The seventh row 616 might be a useful addition to the protocol that enables access points to signal exactly how long a roaming preparation phase remains valid. The timing constraint for the seventh row 616 could be measured in time units, offering the network infrastructure precise control over how long it holds reserved links for a transitioning client. A non-access point multi-link device processing a frame containing the type value from the seventh row 616 may prioritize its roaming execution to ensure it completes the handover before the target node revokes the allocated resources.

In certain embodiments, an eighth row 617 can reserve the extensive block of type values from seven to two hundred and fifty-five. The eighth row 617 might preserve a vast amount of the available numerical identifier space for as-yet-undefined network timing parameters. By keeping the values in the eighth row 617 unassigned, standards bodies could smoothly integrate future mobility, security, or power-management features without conflicting with existing definitions. A legacy access point might be configured to safely ignore any received element that utilizes a type value falling within the range specified by the eighth row 617.

In a non-limiting example, the various definitions established by the timeout interval type table 600 can work together to orchestrate a complex device onboarding and roaming process. An enterprise access point might initially utilize the definition from the second row 611 to enforce a strict reassociation deadline for a newly connecting laptop. Once the laptop is fully authenticated, the access point could send a subsequent management frame based on the third row 612 to establish a long-term key lifetime interval in seconds. Later, as the laptop begins to physically move, the network infrastructure may transmit an updated frame utilizing the designation from the seventh row 616. This final transmission could dictate a precise roaming timeout in time units, ensuring the laptop completes its transition swiftly without holding stale resources on the target node.

For instance, the timeout interval type table 600 might enable an access point to dynamically juggle multiple clients with drastically different timing needs. The access point could simultaneously manage a low-power environmental sensor utilizing the time-to-start parameter from the fifth row 614 and two smart displays negotiating a peer-to-peer connection via the sixth row 615. When a heavily utilized smartphone attempts to roam into the coverage area, the access point may reference the first column 620 to generate a specific signaling element. The access point could then apply the type value of six from the seventh row 616 and transmit a very short deadline in time units, as defined by the third column 640. This precise, type-specific signaling might force the smartphone to transition immediately, thereby preserving the access point’s limited bandwidth for the already active sensor and smart displays.

It is contemplated that the standardized structure of the timeout interval type table 600 can reduce miscommunications between devices manufactured by different vendors across a vast seamless mobility domain. If a wireless client receives a timeout interval element, it could isolate the type field and compare it against the known values located in the first column 620. If the extracted value is a three, the client may substantially understand the meaning established in the second column 630 as an association comeback time. Furthermore, the client would automatically know to interpret the accompanying numerical payload as time units, as dictated by the third column 640, rather than mistakenly processing the value as seconds. This uniform interpretation across all nodes might be absolutely essential for maintaining the delicate timing synchronizations required for advanced features like seamless roaming and robust power management.

Although a specific embodiment for a timeout interval type table 600 for carrying out the various steps, processes, methods, and operations described herein is discussed with respect to FIG. 6, any of a variety of systems and/or devices may be utilized in accordance with embodiments of the disclosure. For example, the specific numerical values assigned to each timing parameter could be rearranged, or entirely different units of measurement might be adopted for future wireless standards. The elements depicted in FIG. 6 may also be interchangeable with other elements of FIGS. 1–5 and 7–15 as required to realize a particularly desired embodiment.

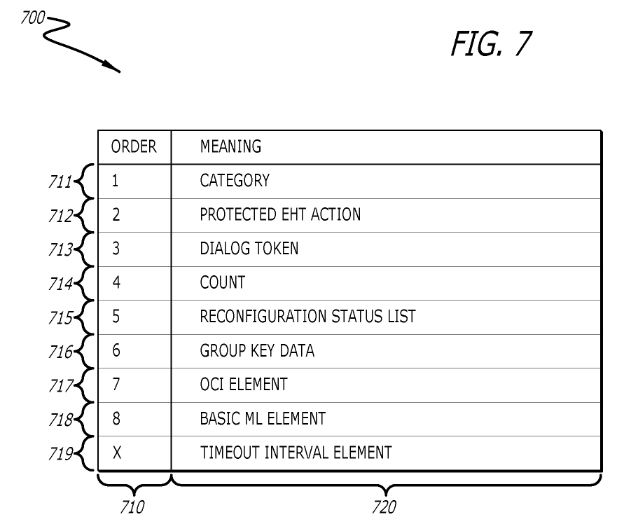

Referring to FIG. 7, a table illustrating a link reconfiguration response frame format in accordance with various embodiments of the disclosure is shown. In various embodiments, a link reconfiguration response table 700 can outline the sequential structure of a highly specialized management frame. The link reconfiguration response table 700 might dictate how an access point packages useful transition parameters during a roaming preparation phase. By adhering to the structural blueprint provided by the link reconfiguration response table 700, network devices could ensure strict interoperability across a seamless mobility domain. Furthermore, the link reconfiguration response table 700 may allow a receiving client to predictably parse and extract time-sensitive configuration data without encountering structural errors.

In many embodiments, an order column 710 can establish the precise sequential arrangement of the individual fields within the transmitted payload. The order column 710 might guarantee that a transmitting node and a receiving node share an identical expectation of the byte stream layout. A network processor parsing a frame according to the order column 710 could systematically step through the data block without typically necessitating complex delimiter searches. Consequently, the order column 710 may heavily optimize the processing speed required to decode the management frame during rapid mobility events.

In some embodiments, a meaning column 720 can provide the functional definitions corresponding to each sequential slot in the frame. The meaning column 720 might serve as a reference for developers to understand the operational context of the data encapsulated at each specific location. When a wireless protocol stack analyzes a received packet, it could apply the logic defined by the meaning column 720 to appropriately route the extracted bytes to memory. Thus, the meaning column 720 may bridge the gap between a raw binary sequence and the complex networking behaviors required for seamless connectivity.

In further embodiments, a first row 711 can correspond to a category field that appears at the very beginning of the sequence. The first row 711 might classify the overarching type of the management action being executed by the access point. A client device reading the data associated with the first row 711 could determine if the frame pertains to a relevant protocol, such as an extremely high throughput operation. This early categorization provided by the first row 711 may act as an initial filter, allowing the hardware to discard irrelevant traffic before expending further processing power.

In additional embodiments, a second row 712 can define a protected extremely high throughput action field. The second row 712 might indicate that the subsequent payload contains sensitive link management instructions that require cryptographic verification. A receiving node processing the data from the second row 712 could trigger its internal security engines to authenticate the origin and integrity of the frame. By enforcing these security measures, the second row 712 may reduce unauthorized entities from maliciously altering a client’s roaming preparation state.

In certain embodiments, a third row 713 can designate a dialog token field utilized for transaction matching. The third row 713 might contain a unique identifier that links this specific response frame back to an initial request transmitted by a client device. When an access point multi-link device generates the response, it could copy the client’s original identifier into the position specified by the third row 713. A roaming device may then utilize the third row 713 to confidently verify that the received parameters accurately correspond to its own pending mobility request.

In numerous embodiments, a fourth row 714 can specify a count field that indicates the volume of subsequent data elements. The fourth row 714 might inform the receiving parser of exactly how many status items or sub-elements are packed into the remainder of the frame. By extracting the numerical value associated with the fourth row 714, a protocol stack could dynamically allocate the exact amount of buffer memory required for the operation. This predictive memory management enabled by the fourth row 714 may reduce the likelihood of buffer overflow vulnerabilities during frame parsing.

In various embodiments, a fifth row 715 can encompass a reconfiguration status list field useful for the roaming preparation phase. The fifth row 715 might contain the explicit operational results confirming which specific communication links were successfully reserved on the target access point. During a complex multi-link transition, the fifth row 715 could individually validate the status of multiple spatial streams or radio bands. A non-access point multi-link device may strictly rely on the contents of the fifth row 715 to definitively know its available networking pathways before severing its current connection.

In some embodiments, a sixth row 716 can define a group key data field for secure multicast communications. The sixth row 716 might seamlessly deliver updated cryptographic keys required to decode domain-wide broadcast messages on the new target node. When transitioning between overlapping coverage areas, the data mapped to the sixth row 716 could supply these necessary keys without forcing the client into a full, time-consuming re-authentication handshake. Consequently, the sixth row 716 may ensure that the transitioning device does not miss useful network announcements during the brief roaming window.

In further embodiments, a seventh row 717 can correspond to an operating class indication element field. The seventh row 717 might define the specific radio frequencies, channel widths, and regulatory domains the target access point actively utilizes. A highly mobile device parsing the parameters associated with the seventh row 717 could quickly and accurately tune its physical radios to the optimal spectrum. This explicit channel signaling provided by the seventh row 717 may drastically reduce the time a client spends scanning the airwaves to establish a physical link.

In additional embodiments, an eighth row 718 can specify a basic multi-link element field. The eighth row 718 might encapsulate the core architectural parameters necessary for devices operating across multiple simultaneous wireless links. The data contained within the location defined by the eighth row 718 could convey link identifiers, hardware addresses, and synchronization timers for the target multi-link device. A sophisticated client station may process the eighth row 718 to meticulously coordinate its various radio transceivers with the complex topology of the new access point.

In certain embodiments, a row 719 having an order of X can introduce a timeout interval element field appended to the end of the management frame. The row 719 might carry the vital roaming timeout that strictly dictates the validity period of the preparation phase. The network infrastructure could utilize the slot defined by the row 719 to explicitly signal exactly how long the previously confirmed link resources may be held in reserve. A client device might extract and obey the parameters provided in the row 719 to align its internal roaming timers with the network’s capacity constraints.

In a non-limiting example, the various fields outlined in the link reconfiguration response table 700 can seamlessly collaborate to finalize a roaming preparation procedure. A target access point might receive an incoming request and begin formatting a response frame according to the sequence established by the order column 710. The access point could populate the third row 713 with a matching dialog token and confirm the reserved communication channels within the fifth row 715. Finally, the access point may append a specific roaming timeout duration into the row 719 corresponding to the order of X, allowing the receiving smartphone to parse the entire structured payload and confidently understand its transition window.

For instance, the link reconfiguration response table 700 might enable an overloaded network node to dynamically protect its limited airtime resources. If a target access point is experiencing severe congestion, it could still accept a roaming request but heavily restrict the allowable transition time. The access point may securely package the frame using the cryptographic measures indicated by the second row 712 and deliver its operating frequencies via the seventh row 717. However, when populating the field corresponding to the row 719 designated by the order of X, the access point might insert a drastically shortened roaming timeout interval, forcing the client to either execute the roam or forfeit the reservations confirmed in the fifth row 715.

It is contemplated that the standardized format of the link reconfiguration response table 700 can ensure reliable context transfers across disparate hardware vendors within a seamless mobility domain. A transitioning laptop could receive this management frame and systematically decode the bytes based on the definitions in the meaning column 720. The laptop might extract its new multicast encryption keys from the sixth row 716 and configure its multi-link radios using the data from the eighth row 718. By reliably extracting the roaming timeout from the row 719 associated with the order of X, the laptop may substantially synchronize its final physical transition with the target node’s internal state machine, thereby achieving a genuinely seamless handover.

Although a specific embodiment for a link reconfiguration response table 700 for carrying out the various steps, processes, methods, and operations described herein is discussed with respect to FIG. 7, any of a variety of systems and/or devices may be utilized in accordance with embodiments of the disclosure. For example, the frame format might be expanded to include additional vendor-specific elements, or the sequence of the fields could be rearranged in future protocol iterations. The elements depicted in FIG. 7 may also be interchangeable with other elements of FIGS. 1–6 and 8–15 as required to realize a particularly desired embodiment.

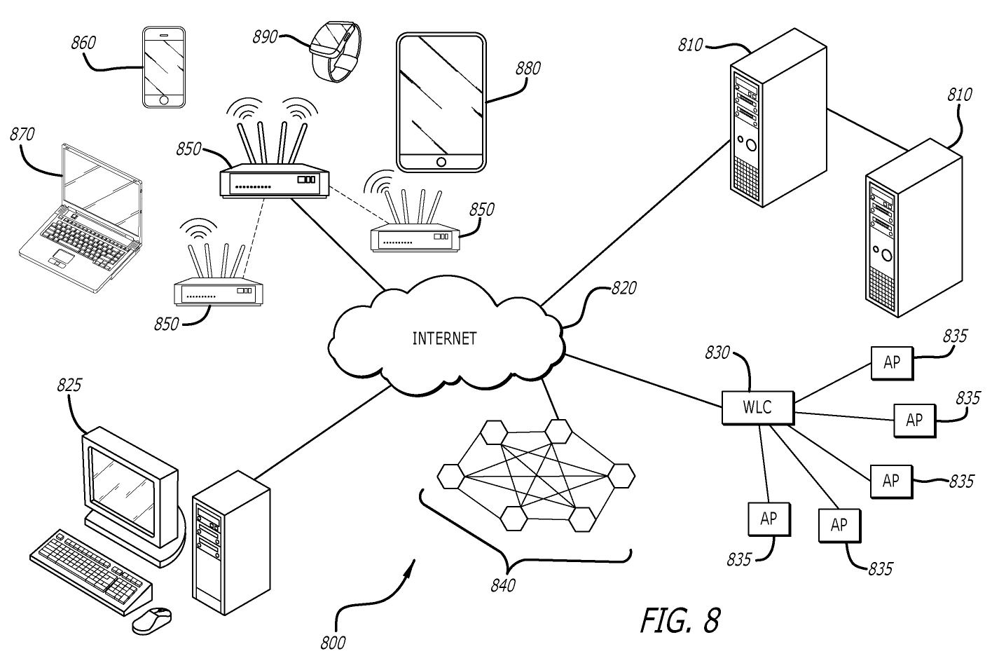

Referring to FIG. 8, a schematic diagram of a multi-link device network environment in accordance with an embodiment of the disclosure is shown. In various embodiments, a deployment environment 800 can illustrate a broad ecosystem of interconnected devices and infrastructure components capable of implementing the seamless roaming logic described herein. The deployment environment 800 might represent a large-scale enterprise network, a campus-wide wireless deployment, or a distributed cloud-based architecture. By utilizing the deployment environment 800, organizations could manage extensive user mobility across a vast geographical area without sacrificing connection stability. Furthermore, the deployment environment 800 may provide the necessary structural foundation to support complex signaling mechanisms and dynamic resource allocation protocols.

In many embodiments, a server 810 can be deployed to handle centralized processing, data storage, and network management tasks. The server 810 might host the core authentication services, security databases, and administrative consoles required to maintain a seamless mobility domain. When client devices transition between different physical locations, the server 810 could securely coordinate the transfer of cryptographic keys and user profiles. Additionally, the server 810 may aggregate telemetry data from various network nodes to dynamically optimize roaming timeouts based on historical traffic patterns.

In some embodiments, an internet 820 can serve as the primary wide area network backbone connecting disparate local area networks and remote resources. The internet 820 might facilitate the routing of data packets between internal enterprise servers and external cloud-hosted applications. As mobile users consume high-bandwidth media or engage in real-time communications, the internet 820 could provide the necessary throughput to support these demanding applications. Furthermore, the internet 820 may enable administrative personnel to remotely monitor and configure the wireless infrastructure from virtually any location in the world.

In further embodiments, a desktop computer 825 can be connected to the broader network infrastructure, often via a stable wired Ethernet connection. The desktop computer 825 might act as an administrative workstation where information technology professionals can configure the global settings for a seamless mobility domain. Through specialized management software running on the desktop computer 825, network engineers could manually define baseline timeout intervals or adjust threshold values for automated load balancing. Consequently, the desktop computer 825 may serve as a useful interface for overseeing the health and performance of the entire wireless deployment.

In additional embodiments, a wireless controller 830 can orchestrate the operations of multiple downstream wireless access nodes. The wireless controller 830 might centralize the control plane, allowing for unified policy enforcement, radio frequency management, and seamless roaming coordination. As a client device moves across the coverage area, the wireless controller 830 could intercept mobility requests and dictate the precise transition timing constraints based on real-time network visibility. By leveraging the wireless controller 830, a deployment might achieve a highly synchronized and efficient distribution of wireless resources.

In certain embodiments, an access point 835 can provide the physical wireless coverage necessary for client devices to connect to the network. The access point 835 might operate as a multi-link device capable of transmitting and receiving data across several different frequency bands simultaneously. When a mobile device approaches, the access point 835 could receive a roaming preparation request and temporarily reserve communication links to facilitate a smooth handover. Furthermore, the access point 835 may dynamically generate and transmit specific signaling frames containing execution deadlines to govern exactly when the transition must occur.

In numerous embodiments, a distributed network 840 can represent a mesh-like topology of interconnected routing nodes or edge computing devices. The distributed network 840 might process data locally at the network edge rather than relying on a centralized server for every decision. By utilizing the distributed network 840, the infrastructure could rapidly share context information and load metrics between neighboring nodes with extremely low latency. This decentralized approach enabled by the distributed network 840 may greatly enhance the speed and reliability of roaming preparations within densely populated environments.

In various embodiments, a wireless router 850 can serve as a versatile gateway device that combines routing, switching, and wireless access point functionalities. The wireless router 850 might be deployed in smaller branch offices or home environments to provide localized seamless roaming capabilities. A cluster of devices operating as the wireless router 850 could communicate with each other to manage handoffs without typically necessitating a dedicated, stand-alone controller. Additionally, the wireless router 850 may analyze its own processing load and memory availability to determine appropriate timeout intervals for incoming client devices.

In some embodiments, a smartphone 860 can represent a highly mobile client device that frequently traverses different wireless coverage zones. The smartphone 860 might run numerous background applications, voice-over-IP services, and streaming media clients that demand persistent, uninterrupted connectivity. To satisfy these demands, the smartphone 860 could proactively scan the environment, evaluate signal strengths, and initiate roaming preparations well before its current link degrades. Upon receiving a targeted deadline interval, the smartphone 860 may prioritize its internal processing to ensure the roaming execution is finalized in a timely manner.

In further embodiments, a laptop 870 can be utilized by a user moving between different conference rooms or office buildings. The laptop 870 might engage in complex multi-link operations, simultaneously leveraging multiple radio interfaces to increase data throughput. When transitioning between access points, the laptop 870 could require the transfer of additional dynamic context, such as block acknowledgment agreements and packet sequence numbers. The laptop 870 may carefully parse incoming management frames to extract network-imposed timing constraints and adjust its transition algorithms accordingly.

In additional embodiments, a tablet 880 can provide a portable computing platform for multimedia consumption and productivity tasks. The tablet 880 might alternate between periods of high network utilization and low-power sleep states to conserve its internal battery reserves. During a mobility event, the tablet 880 could benefit from extended roaming execution deadlines if the target infrastructure is lightly loaded. By receiving and interpreting these dynamically adjusted intervals, the tablet 880 may execute its transition at a more power-efficient pace without losing its reserved connection slot.

In certain embodiments, a smartwatch 890 can operate as a wearable client device with strict power and processing limitations. The smartwatch 890 might rely heavily on the network infrastructure to orchestrate seamless transitions with minimal computational overhead. As a user walks through a campus, the smartwatch 890 could leverage simplified signaling procedures to securely migrate its active sessions between overlapping access points. The network might recognize the constrained nature of the smartwatch 890 and tailor specific timeout intervals to ensure its connectivity remains intact without rapidly draining its battery.

In a non-limiting example, the various components of the deployment environment 800 can interact to manage a seamless handover for a roaming user. The smartphone 860 might be streaming a video from the internet 820 while connected to a first instance of the access point 835. As the user walks, the smartphone 860 could detect a stronger signal from a second instance of the access point 835 and send a preparation request. The wireless controller 830 may oversee this request, coordinate the context transfer between the two instances of the access point 835, and instruct the target node to provide a specific execution deadline. The smartphone 860 might then complete the transition within the specified timeframe, maintaining the video stream without any buffering.

For instance, the deployment environment 800 might utilize edge computing principles to dynamically optimize network resources during a highly congested event. If a large number of users with devices such as the laptop 870 and the tablet 880 congregate in a single auditorium, the local instance of the wireless router 850 may become heavily burdened. The distributed network 840 could detect this localized congestion and instruct the wireless router 850 that is overwhelmed to issue extremely short roaming execution deadlines to any newly arriving devices. Concurrently, the server 810 might log these congestion events to help the desktop computer 825 visualize the traffic bottlenecks for the network administrators.

It is contemplated that the deployment environment 800 can scale seamlessly from localized configurations to massive, globally distributed architectures. The smartwatch 890 might initially connect to a wireless router 850 that is home-based, utilizing a specific set of roaming timing parameters optimized for a quiet environment. Later, as the user travels to a corporate headquarters, the smartwatch 890 could interface with a complex array of devices acting as the access point 835, all managed by a wireless controller 830 that is powerful. Despite the drastic change in the physical infrastructure, the underlying signaling logic processed by the server 810 and the distributed network 840 may ensure that the smartwatch 890 consistently receives correctly formatted timeout elements to guide its roaming behavior.

Although a specific embodiment for a deployment environment 800 for carrying out the various steps, processes, methods, and operations described herein is discussed with respect to FIG. 8, any of a variety of systems and/or devices may be utilized in accordance with embodiments of the disclosure. For example, cloud-hosted virtual controllers could entirely replace on-premises hardware, or emerging cellular technologies might be integrated alongside the wireless local area network infrastructure. Furthermore, the specific topology and arrangement of the interconnected devices can be modified to meet the distinct operational requirements of different enterprises. The elements depicted in FIG. 8 may also be interchangeable with other elements of FIGS. 1–7 and 9–15 and as required to realize a particularly desired embodiment.

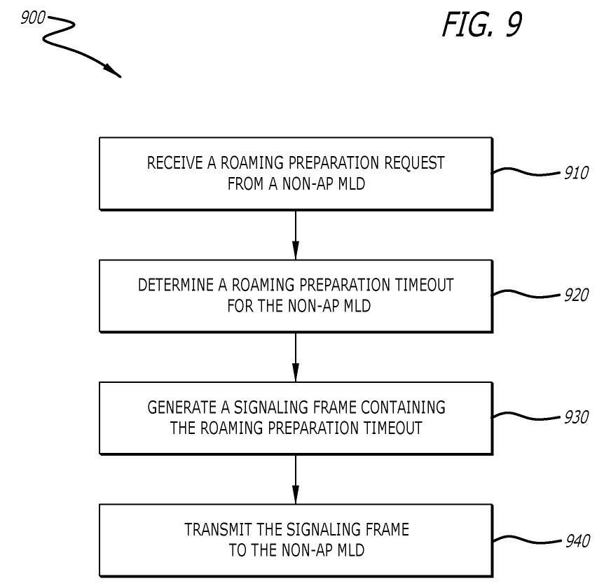

Referring to FIG. 9, a flowchart depicting a process 900 for roaming execution deadline signaling for seamless roaming in accordance with various embodiments of the disclosure is shown. The process 900 can represent a logical sequence of operations executed by a network device, such as an access point multi-link device, to manage wireless transitions. In various embodiments, the process 900 can be implemented as machine-readable instructions stored on a non-transitory memory and executed by a processor. By employing the process 900, the network infrastructure may efficiently balance its resource reservations against the mobility needs of connected clients.

In many embodiments, the process 900 can receive a roaming preparation request from a non-AP MLD (block 910). The request may be received over a wireless communication channel established between the non-AP MLD and a current access point. For example, the non-AP MLD could broadcast the request across multiple available channels to discover the most optimal target access point for an impending transition. Alternatively, the network infrastructure might route the preparation request through a backhaul connection from a currently associated access point to a target access point. In a non-limiting example, a central wireless controller may intercept the initial transmission and direct the preparation requirements to the appropriate local node to reserve resources.

In a number of embodiments, the process 900 can determine a roaming timeout for the non-AP MLD (block 920). The deadline interval may be calculated dynamically based on real-time network congestion and the current resource load of the target access point. For instance, if the target access point is lightly loaded, a longer interval might be assigned to give the client device more flexibility in executing its transition. In other approaches, the deadline interval could simply be a static baseline value configured globally for an entire seamless mobility domain by a network administrator. It is contemplated that the determination could involve evaluating the specific service level requirements of the non-AP MLD, assigning a much shorter deadline to devices utilizing high-bandwidth applications to reduce prolonged resource reservation.

In more embodiments, the process 900 can generate a signaling frame containing the roaming preparation timeout (block 930). The signaling frame may be structured as a dedicated roaming preparation response configured to directly answer the initial request. For example, the response might encapsulate the deadline interval within a specific timeout interval element alongside other link reconfiguration parameters. Conversely, the generated frame could take the form of a periodic broadcast message, such as a beacon or a probe response, meant for multiple listeners within the coverage area. In a non-limiting example, the signaling frame can include a seamless mobility domain element where the deadline interval is appended as a distinct data field measured in multiples of a standard time unit.

In further embodiments, the process 900 can transmit the signaling frame to the non-AP MLD (block 940). The transmission may occur directly over the air interface from a target access point to the client device utilizing a unicast communication protocol. For instance, the signaling frame might be securely delivered utilizing cryptographic keys to ensure that the deadline parameters cannot be intercepted or modified by malicious actors. In another configuration, the transmission could be orchestrated as a multicast broadcast that reaches numerous non-AP MLDs simultaneously. It is contemplated that the transmission might be relayed through an intermediate node or a current access point if the client device has not yet established a direct physical link with the target destination.

Although a specific embodiment for a process 900 for roaming execution deadline signaling for seamless roaming suitable for carrying out the various steps, processes, methods, and operations described herein is discussed with respect to FIG. 9, any of a variety of systems and/or processes may be utilized in accordance with embodiments of the disclosure. For example, the process 900 may include additional operations for negotiating the specific time units or metrics used to measure the deadline interval before generating the signaling frame. Furthermore, the network infrastructure could repeatedly execute the process 900 to persistently update the deadline interval as local traffic conditions fluctuate over time. The elements depicted in FIG. 9 may also be interchangeable with other elements of FIGS. 1–8 and 10–15 as required to realize a particularly desired embodiment.

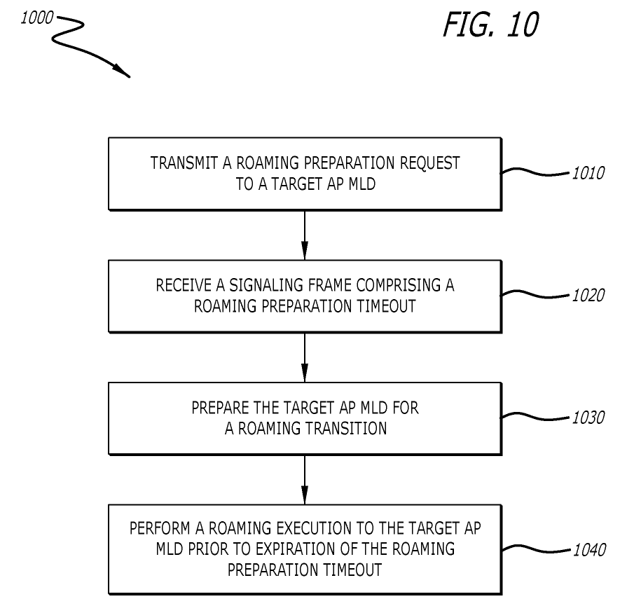

Referring to FIG. 10, a flowchart depicting a process 1000 for seamless network roaming in accordance with various embodiments of the disclosure is shown. The process 1000 can represent a logical sequence of operations executed by a client device, such as a non-access point multi-link device, to manage wireless transitions. In various embodiments, the process 1000 can be implemented as machine-readable instructions stored on a non-transitory memory and executed by a processor. By employing the process 1000, the client device may efficiently manage its connectivity while adhering to the resource reservation constraints imposed by the network infrastructure.

In many embodiments, the process 1000 can transmit a roaming preparation request to a target AP MLD (block 1010). The transmission may be initiated based on evaluating neighbor information, such as access point load, or received signal strength indicator measurements. For example, a mobile client may persistently monitor nearby access points and trigger the transmission upon detecting a stronger signal from an adjacent network node. In other approaches, the transmission could be routed through a currently associated access point over a backhaul network rather than sent directly over the air to the intended destination.

In a number of embodiments, the process 1000 can receive a signaling frame comprising a roaming preparation timeout (block 1020). The received frame could be a dedicated link reconfiguration response generated specifically to answer a prior preparation inquiry. For instance, a network infrastructure might encapsulate the deadline interval within a specific timeout interval element alongside other link parameters intended for a single transitioning client. Conversely, the signaling frame might be a periodic broadcast message, such as a beacon or a probe response, meant to provide a baseline interval for multiple listeners within the coverage area.

In more embodiments, the process 1000 can prepare the target AP MLD for a roaming transition (block 1030). This preparation may involve setting up new communication links and transferring essential operational context without interrupting the active connectivity on the current link. In a non-limiting example, the context transfer could include reserving resources for spatial streams or block acknowledgment agreements in advance of the physical handover. Alternatively, the preparation might be limited to simply authenticating the client device and holding cryptographic keys in reserve until the final transition is formally executed.

In further embodiments, the process 1000 can perform a roaming execution to the target AP MLD prior to expiration of the roaming preparation timeout (block 1040). The execution may involve a dynamic context transfer, such as updating changing sequence numbers or packet numbers, and mapping the client to the new distribution system. For example, a transitioning smartphone could shift its active data routing to the new node right before the deadline expires, thereby maintaining an uninterrupted data stream. In other situations, if the execution is not completed within the prescribed timeframe, the target node might completely delete the reserved preparation state, forcing the client to begin the procedure anew.

Although a specific embodiment for a process 1000 for seamless network roaming suitable for carrying out the various steps, processes, methods, and operations described herein is discussed with respect to FIG. 10, any of a variety of systems and/or processes may be utilized in accordance with embodiments of the disclosure. For example, the process 1000 may incorporate additional procedures for actively renegotiating the deadline interval if the initial allocation proves insufficient. Furthermore, the timing mechanisms associated with the expiration of the deadline can be adapted to utilize various time units depending on the underlying hardware capabilities. The elements depicted in FIG. 10 may also be interchangeable with other elements of FIGS. 1–9 and 11–15 as required to realize a particularly desired embodiment.

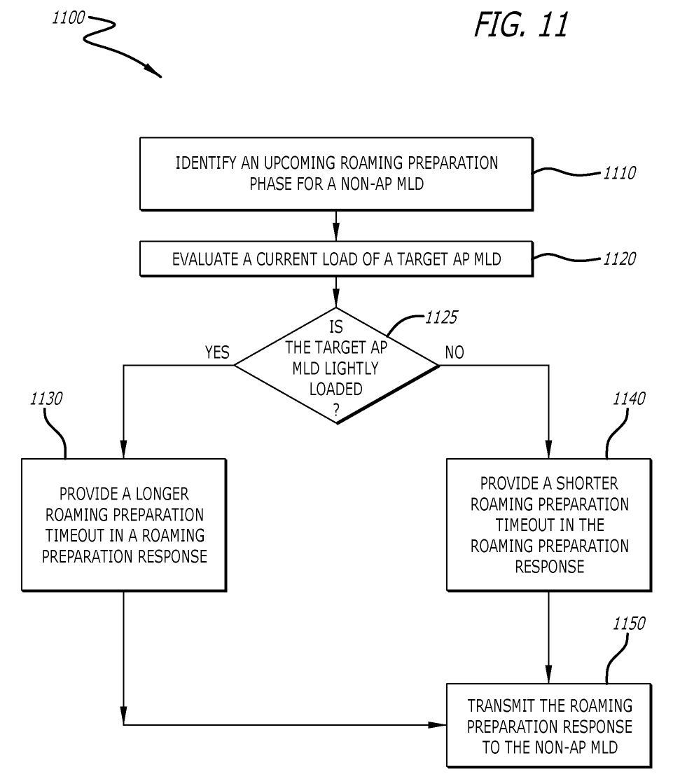

Referring to FIG. 11, a flowchart depicting a process 1100 for determining a roaming timeout based on a target access point load in accordance with various embodiments of the disclosure is shown. The process 1100 can represent a logical sequence of operations executed by a network device, such as an access point multi-link device, to manage wireless transitions efficiently. In various embodiments, the process 1100 can be implemented as machine-readable instructions stored on a non-transitory memory and executed by a processor. By employing the process 1100, the network infrastructure may dynamically balance its resource reservations against the mobility needs of connected clients to reduce congestion.

In many embodiments, the process 1100 can identify an upcoming roaming preparation phase for a non-AP MLD (block 1110). In some instances, the network infrastructure may anticipate this phase based on receiving an initial request or observing degrading signal metrics from the connected client device. Alternatively, a centralized controller might predict the movement of the device through the coverage area and proactively signal the impending transition to the necessary network nodes. For example, a smartphone moving toward the edge of its current basic service set may trigger a threshold that alerts the target access point to begin allocating resources. It is contemplated that identifying the phase early allows the system to organize communication links efficiently before any actual data transmission is interrupted.

In a number of embodiments, the process 1100 can evaluate a current load of a target AP MLD (block 1120). The evaluation can involve measuring the active bandwidth utilization, memory capacity, and processing overhead currently experienced by the target access point. In other approaches, the evaluation might simply count the total number of connected clients and compare this figure against a maximum capacity threshold. For instance, a network node deployed in a highly congested auditorium may persistently poll its internal hardware to assess how many additional devices it can reliably support without degrading service for existing users. In a non-limiting example, the network could leverage historical traffic patterns combined with real-time analytics to comprehensively evaluate the load before accepting new mobility requests.

In further embodiments, the process 1100 can determine if the target AP MLD is lightly loaded (block 1125). This determination can rely on comparing the metrics gathered during the evaluation phase against one or more predefined administrative thresholds. If it is determined that the target AP MLD is lightly loaded, then the process 1100 can provide a longer roaming timeout in a roaming preparation response (block 1130). However, if it is determined that the target AP MLD is not lightly loaded, then some embodiments of the process 1100 can provide a shorter roaming timeout in the roaming preparation response (block 1140). For example, categorizing the load appropriately ensures that the network dynamically tailors its resource holding times to match the physical realities of the current environment.

In additional embodiments, the process 1100 can provide a longer roaming preparation timeout in a roaming preparation response (block 1130). By offering an extended duration, the access point grants the client device additional flexibility to delay its physical transition until the optimal moment. In alternative scenarios, the extended duration might be selected from a predefined list of acceptable time units that far exceed the standard baseline timeout broadcasted across the seamless mobility domain. For instance, a tablet operating in a nearly empty office wing could receive a generous deadline interval, allowing it to complete background synchronization tasks on its current link before formally executing the roam. It is contemplated that providing this longer value reduces unnecessary dropped connections when the target infrastructure has abundant airtime resources available to hold the reservation indefinitely.

In still more embodiments, the process 1100 can provide a shorter roaming preparation timeout in the roaming preparation response (block 1140). A restricted deadline ensures that the target node does not maintain idle reservations for prolonged periods while other active devices are simultaneously competing for limited bandwidth. Conversely, the restricted deadline might be dynamically calculated to be precisely the minimum amount of time required for an average device to accomplish a dynamic context transfer. In a non-limiting example, a heavily utilized wireless router in a crowded stadium may force transitioning smartphones to either execute their roam or forfeit their reserved links, thereby increasing overall network throughput. This aggressive resource management approach can protect the target access point from being overwhelmed by stale preparation states during peak usage events.

In yet further embodiments, the process 1100 can transmit the roaming preparation response to the non-AP MLD (block 1150). The transmission can occur directly over the active wireless medium using a dedicated management frame tailored to the specific client. In some approaches, the transmission might be routed securely through the backhaul infrastructure to the device’s currently associated access point, which then relays the message. For example, the response may encapsulate the carefully determined deadline interval within a timeout interval element, enabling the client device’s protocol stack to parse the constraints seamlessly. It is contemplated that once the transmission is complete, the target node initiates a corresponding internal timer to actively monitor whether the client executes the roam before the newly signaled deadline expires.

Although a specific embodiment for a process 1100 for determining a roaming timeout based on a target access point load suitable for carrying out the various steps, processes, methods, and operations described herein is discussed with respect to FIG. 11, any of a variety of systems and/or processes may be utilized in accordance with embodiments of the disclosure. Additionally, the use of optional embodiments does not indicate that the remaining elements are non-optional, but is presented to highlight a separate embodiment and/or to indicate when a decision may be made to not utilize this element. For example, the process 1100 could incorporate intermediate load categories that trigger medium-length deadline intervals, rather than relying strictly on a binary determination of lightly or heavily loaded states. The elements depicted in FIG. 11 may also be interchangeable with other elements of FIGS. 1–10 and 12–15 as required to realize a particularly desired embodiment.

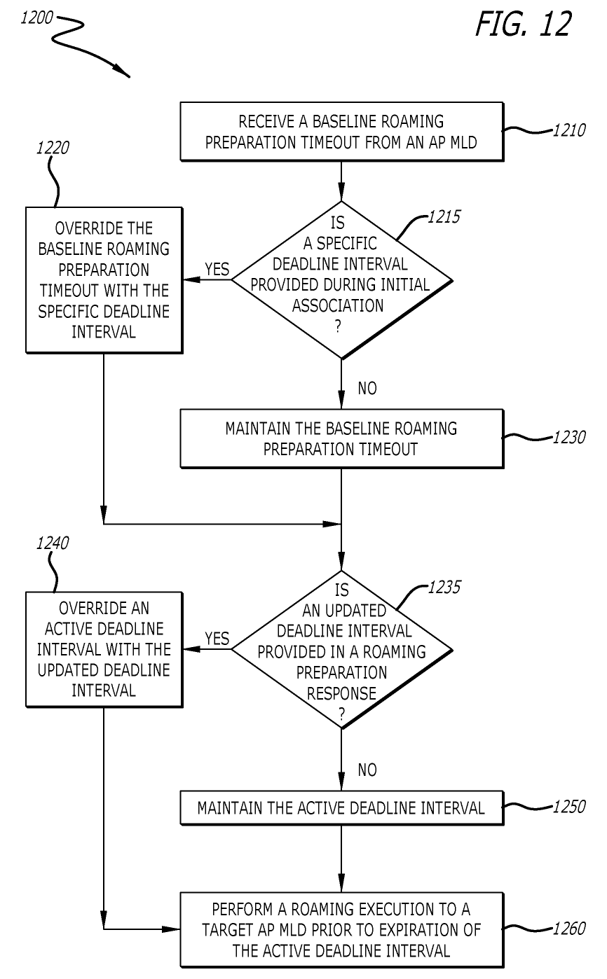

Referring to FIG. 12, a flowchart depicting a process 1200 for overriding a baseline roaming timeout in accordance with various embodiments of the disclosure is shown. In many embodiments, the process 1200 can receive a baseline roaming preparation timeout from an AP MLD (block 1210). The baseline interval can be received via a broadcast management frame, such as a beacon, transmitted across the entire mobility domain. For example, a mobile client may actively scan the wireless channels and parse the seamless mobility domain element to extract the globally applicable time constraints. In alternative scenarios, the baseline roaming timeout may be obtained through a directed probe response during active network discovery.

In a number of embodiments, the process 1200 can determine if a specific deadline interval is provided during initial association (block 1215). If it is determined that a specific deadline interval is not provided during initial association, then some embodiments of the process 1200 can maintain the baseline roaming timeout (block 1230). However, if a specific deadline interval is provided during initial association, then the process 1200 can override the baseline roaming preparation timeout with the specific deadline interval (block 1220). This evaluation may allow the device to recognize when the network infrastructure intends to apply a unique timing rule rather than relying on the globally broadcast parameters.

In further embodiments, the process 1200 can maintain the baseline roaming preparation timeout (block 1230). Maintaining the globally broadcast parameter might ensure that the device follows the standardized timing constraints expected by the overarching mobility domain. For instance, a smart display that connects to the network during a period of normal traffic might not receive any specialized overrides, leading it to rely entirely on the baseline values extracted from the beacon. Alternatively, maintaining this baseline duration may reduce the client from prematurely dropping its preparation state when the access point has sufficient resources to honor the default reservation period.

In additional embodiments, the process 1200 can override the baseline roaming timeout with the specific deadline interval (block 1220). This override may be triggered when the network explicitly communicates a client-specific constraint within a reassociation response frame. In a non-limiting example, if the initial association procedure dictates a much longer timeline for a dedicated sensor, the client device may adopt this specific parameter to govern its roaming behavior. In other implementations, the specific deadline interval could be shorter than the baseline roaming timeout, potentially forcing the client to expedite its transitions during its session.

In still more embodiments, the process 1200 can determine if an updated deadline interval is provided in a roaming preparation response (block 1235). If it is determined that an updated deadline interval is not provided in a roaming preparation response, then some embodiments of the process 1200 can maintain the active deadline interval (block 1250). However, if an updated deadline interval is provided in a roaming preparation response, then the process 1200 can override an active deadline interval with the updated deadline interval (block 1240). By checking for this latest parameter, the client device could ensure it adheres to the most current resource constraints imposed by the target access point precisely at the moment of transition.

In yet further embodiments, the process 1200 can maintain the active deadline interval (block 1250). The active interval may be either the original baseline parameter or the specific parameter acquired during the initial connection phase. For example, if a target access point is operating under normal load conditions, it may omit any timing updates in its link reconfiguration response, which could prompt the roaming laptop to simply continue using its previously established active deadline. In another setup, maintaining the active duration might guarantee that the client device does not inadvertently shorten its transition window when the network lacks the capacity to supply fresh scheduling data.

In numerous embodiments, the process 1200 can override an active deadline interval with the updated deadline interval (block 1240). The target node may supply this updated parameter dynamically to reflect its instantaneous congestion levels just before the roam occurs. For instance, a heavily utilized access point might transmit a short updated deadline interval, which could compel the transitioning smartphone to apply this new limit in place of its relaxed active deadline. Alternatively, the updated value might be longer, which may permit the client to comfortably delay its final transition steps without risking the loss of its reserved communication context.

In some embodiments, the process 1200 can perform a roaming execution to a target AP MLD prior to expiration of the active deadline interval (block 1260). Executing the roam might involve finalizing the transfer of the data path and ensuring the distribution system mapping accurately reflects the device’s new attachment point. In a non-limiting example, the client may synchronize its internal timers with the active deadline and complete the handoff of its sequence numbers mere milliseconds before the target access point revokes the reservation. If the device fails to accomplish this execution before the time limit is reached, the network may gracefully delete the prepared links, which could require the mobility procedure to be reinitiated from scratch.

Although a specific embodiment for a process 1200 for overriding a baseline roaming timeout suitable for carrying out the various steps, processes, methods, and operations described herein is discussed with respect to FIG. 12, any of a variety of systems and/or processes may be utilized in accordance with embodiments of the disclosure. For example, the process 1200 may include additional operations to explicitly negotiate the granular time units utilized for the various deadline intervals. The elements depicted in FIG. 12 may also be interchangeable with other elements of FIGS. 1–11 and 13–15 as required to realize a particularly desired embodiment.

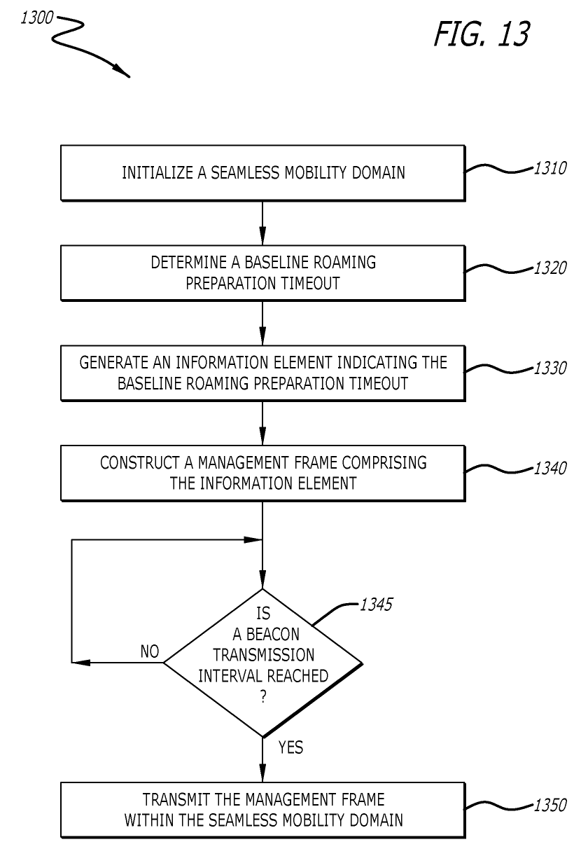

Referring to FIG. 13, a flowchart depicting a process 1300 for broadcasting a baseline roaming timeout in accordance with various embodiments of the disclosure is shown. In many embodiments, the process 1300 can initialize a seamless mobility domain (block 1310). Initializing the domain may involve establishing a group of access point multi-link devices that share a common identifier and security context. For example, a central wireless controller could synchronize numerous access points across a corporate campus to form a unified network presence. In alternative scenarios, a single access point might initialize the domain independently to support future expansion within a smaller office environment. It is contemplated that initializing this domain allows client devices to move freely without needing to regenerate temporal keys at each new connection point.

In a number of embodiments, the process 1300 can determine a baseline roaming preparation timeout (block 1320). Determining this interval might involve assessing the overall average load expected across all nodes within the configured domain. For instance, an administrator might configure a static default interval of one hundred and twenty-eight time units to ensure basic stability for legacy client devices. Conversely, the determination could be fully automated, relying on artificial intelligence models to establish an optimal baseline derived from historical traffic patterns. By establishing this baseline, the network ensures that all clients share a common expectation of how long target nodes will reserve resources for transitions.

In more embodiments, the process 1300 can generate an information element indicating the baseline roaming preparation timeout (block 1330). Generating the element can include structuring the determined timing constraint into a specifically formatted sequence of bytes, such as a timeout interval element or a seamless mobility domain element. In a non-limiting example, the interval could be formatted as a one-octet field indicating multiples of sixty-four time units to reduce the data payload size. Alternatively, the element might be generated with a multi-octet value to accommodate much longer timeout durations required by specialized low-power sensors. Creating this discrete information element may allow the protocol stack to efficiently encapsulate the mobility parameters without disrupting other essential network configuration data.

In further embodiments, the process 1300 can construct a management frame comprising the information element (block 1340). Constructing the frame might involve embedding the generated element into a broader payload designed to govern client behavior across the wireless medium. For example, the element could be inserted into a beacon frame that serves to announce the presence and capabilities of the access point to all listening devices. In other configurations, the management frame might be constructed as a directed probe response triggered only when an unassociated client explicitly requests network details. By packaging the element within a standard management frame, the network infrastructure can seamlessly distribute the baseline roaming parameters utilizing existing communication protocols.

In still more embodiments, the process 1300 can determine if a beacon transmission interval is reached (block 1345). If the beacon transmission interval is not reached, then the process 1300 can once again determine if the beacon transmission interval is reached (block 1345). However, if the beacon transmission interval is reached, then the process 1300 can transmit the management frame within the seamless mobility domain (block 1350). Evaluating this interval may ensure that the network does not flood the airwaves with persistent broadcasts, thereby preserving valuable spectrum for active user data. In a non-limiting example, the access point could monitor an internal hardware timer synchronized to the network’s established target beacon transmission time to make this determination.

In additional embodiments, the process 1300 can transmit the management frame within the seamless mobility domain (block 1350). The transmission could be executed as an omnidirectional broadcast intended to reach every client device currently situated within the physical coverage area. For instance, the transmission might be encoded using a robust, low-data-rate modulation scheme to guarantee successful reception even by devices located at the very edge of the cell boundaries. In alternative setups, the frame could be delivered utilizing multi-user transmission techniques to target a specific group of actively listening stations simultaneously. Distributing this management frame ensures that all prospective roaming clients possess the updated baseline deadline before they initiate any preparation requests.

Although a specific embodiment for a process 1300 for broadcasting a baseline roaming timeout suitable for carrying out the various steps, processes, methods, and operations described herein is discussed with respect to FIG. 13, any of a variety of systems and/or processes may be utilized in accordance with embodiments of the disclosure. For example, the process 1300 may also incorporate steps to encrypt the management frame prior to transmission to reduce unauthorized eavesdropping. The elements depicted in FIG. 13 may also be interchangeable with other elements of FIGS. 1–12 and 14–15 as required to realize a particularly desired embodiment. Additionally, the use of optional embodiments does not indicate that the remaining elements are non-optional, but is presented to highlight a separate embodiment.

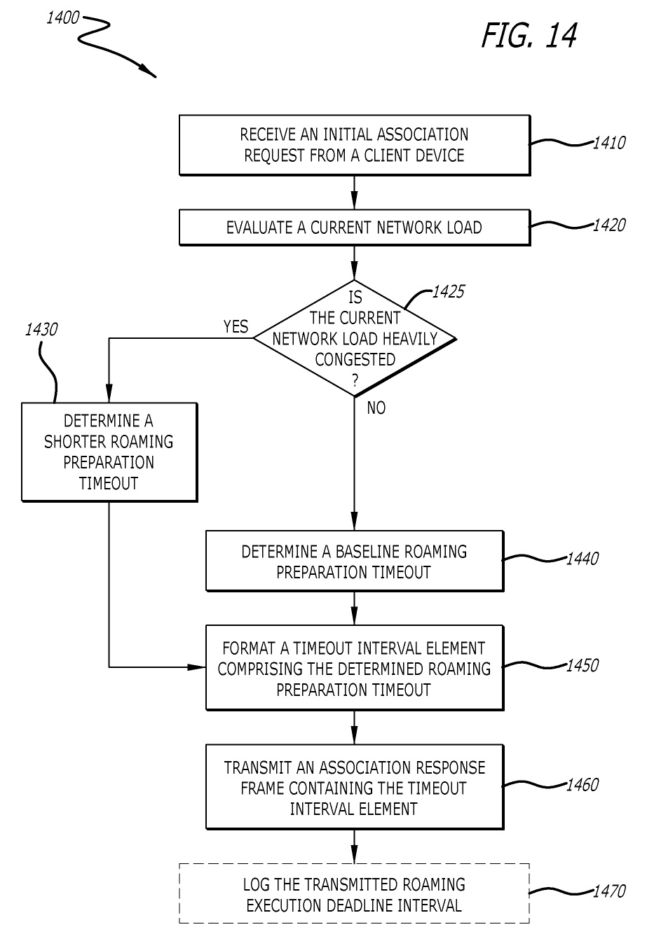

Referring to FIG. 14, a flowchart depicting a process 1400 for determining a roaming timeout based on network congestion in accordance with various embodiments of the disclosure is shown. The process 1400 can represent a highly dynamic configuration mechanism executed by network infrastructure components during device onboarding. In various embodiments, the process 1400 can be implemented as machine-readable instructions stored on a non-transitory memory and executed by a physical processor. By employing the process 1400, an access point may proactively protect its available airtime resources from being monopolized by transitioning clients during periods of heavy utilization.

In many embodiments, the process 1400 can receive an initial association request from a client device (block 1410). The request may be received wirelessly over a designated control channel when a mobile station first powers on within the coverage area. Alternatively, the reception could occur over a wired backhaul interface if the request is being forwarded by a neighboring node in a distributed architecture. For instance, a smart thermostat might broadcast this request to initiate its integration into the local seamless mobility domain. It is contemplated that the receiving infrastructure could mandate specific authentication protocols be completed following this initial reception.

In a number of embodiments, the process 1400 can evaluate a current network load (block 1420). Evaluating this metric might involve persistently polling the hardware queues of an access point multi-link device to assess active buffer utilization. In another approach, the evaluation could rely on a centralized server analyzing historical traffic logs to predict the congestion level for a given time of day. For example, an enterprise deployment may utilize machine learning algorithms to process these load metrics across hundreds of access points simultaneously. This assessment allows the infrastructure to understand its true available capacity before granting resources to newly associating devices.

In more embodiments, the process 1400 can determine if the current network load is heavily congested (block 1425). If it is determined that the current network load is heavily congested, then the process 1400 can determine a shorter roaming timeout (block 1430). However, if it is determined that the current network load is not heavily congested, then some embodiments of the process 1400 can determine a baseline roaming timeout (block 1440). In a non-limiting example, making this dynamic determination ensures that an overloaded access point does not unnecessarily promise long-term resource reservations to highly mobile client devices.

In further embodiments, the process 1400 can determine a shorter roaming preparation timeout (block 1430). A reduced interval may be calculated by applying a fixed percentage reduction to the standard timeout value to quickly free up memory buffers. Alternatively, the shortened duration could be selected from a predefined table of strict timing constraints specifically designed for emergency or high-density scenarios. For instance, a router deployed in a crowded stadium might severely restrict the interval to a few milliseconds to force transitioning smartphones to hand over immediately. It is contemplated that applying this restrictive timing parameter protects the access point from maintaining stale, unused communication links while other users are actively awaiting service.

In additional embodiments, the process 1400 can determine a baseline roaming preparation timeout (block 1440). The baseline parameter might represent a globally standardized duration, such as one hundred and twenty-eight time units, applicable to all generic nodes within the domain. In other implementations, the baseline could be a moderately flexible value that provides client devices with ample time to complete background tasks before committing to a roam. For example, a laptop connecting to a quiet office network may be granted this relaxed baseline constraint to ensure its ongoing data synchronization is not abruptly terminated. Providing a standard baseline reduces unnecessary transitions and offers a stable, predictable connection lifecycle when the network is not under duress.

In still more embodiments, the process 1400 can format a timeout interval element comprising the determined roaming preparation timeout (block 1450). Formatting this data structure could involve encoding the calculated time units into a specific four-octet value field appended to a standard element identifier. Conversely, the formatting might integrate the timing parameter directly into a broader seamless mobility domain element to reduce the overall management frame size. In a non-limiting example, the infrastructure could dynamically assign a unique timeout interval type value to explicitly flag the data as a roaming execution constraint. This careful structuring guarantees that any receiving protocol stack can unambiguously parse and interpret the temporal instructions.

In yet further embodiments, the process 1400 can transmit an association response frame containing the timeout interval element (block 1460). The transmission may be executed utilizing a robust, low-throughput modulation scheme to ensure the useful timing data successfully penetrates physical obstacles. In a different embodiment, the delivery could leverage multi-link operations to send the response frame redundantly across multiple distinct frequency bands. For instance, a target access point might beamform the transmission directly toward the specific spatial coordinates of the requesting client device to increase signal clarity. It is contemplated that transmitting this structured response effectively concludes the initial negotiation, establishing the firm deadlines the client must obey for future mobility events.

In certain optional embodiments, the process 1400 can log the transmitted roaming timeout (block 1470). Logging this data might involve writing the assigned interval and the client’s hardware address to a local solid-state storage drive for temporary auditing. Alternatively, the records could be persistently streamed to a remote cloud-based server for long-term historical analysis and machine learning model training. For example, network administrators may review these logs after a major event to understand how effectively the dynamic deadline adjustments mitigated severe congestion spikes. Recording these specific timing assignments provides invaluable telemetry that can be used to further refine the seamless roaming algorithms in future software updates.

Although a specific embodiment for a process 1400 for determining a roaming timeout based on network congestion suitable for carrying out the various steps, processes, methods, and operations described herein is discussed with respect to FIG. 14, any of a variety of systems and/or devices may be utilized in accordance with embodiments of the disclosure. For example, the process 1400 may skip the logging phase or integrate additional security verifications. Additionally, the use of optional embodiments does not indicate that the remaining elements are non-optional, but is presented to highlight a separate embodiment. The elements depicted in FIG. 14 may also be interchangeable with other elements of FIGS. 1–13 and 15 as required to realize a particularly desired embodiment.

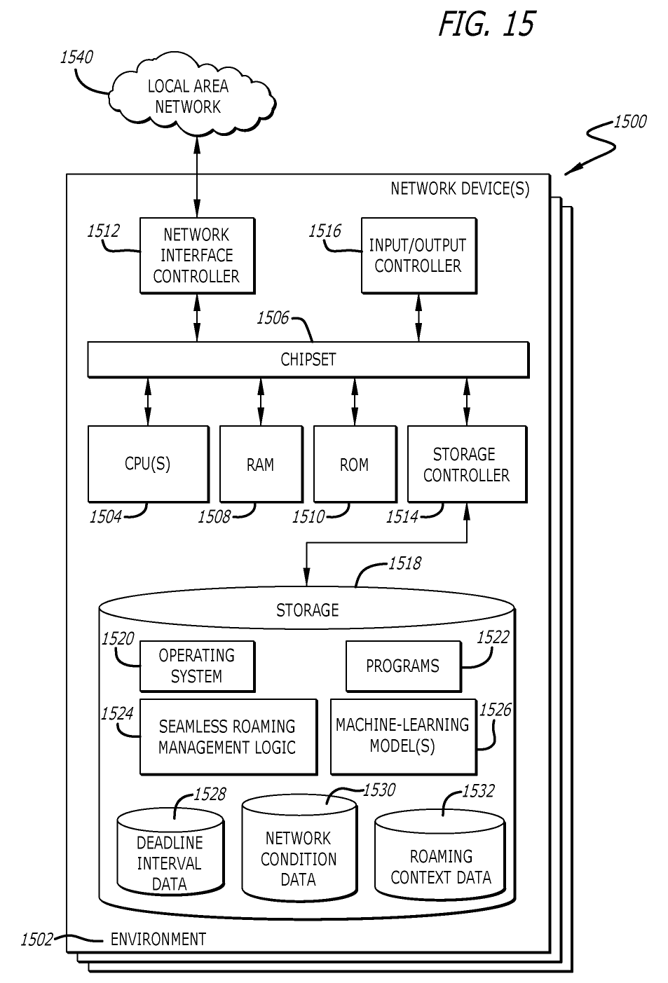

Referring to FIG. 15, a conceptual block diagram of a device 1500 suitable for configuration with a seamless roaming management logic 1524 for implementing the functionality and various embodiments of the disclosure is shown. The embodiment of the device 1500 in the conceptual block diagram depicted in FIG. 15 may relate to a conventional server computer, a workstation, a desktop computer, a laptop, a tablet, a network appliance, an electronic reader, a smartphone, or other computing device, and can be utilized to execute any of the application and/or logic components presented herein. The device 1500 may, in some examples, correspond to a physical device or to a virtual resource described herein. The device 1500 can be a network device, for example, an access point, a router, a switch, any type of edge-based network device, a server, a system, or the like in accordance with various embodiments of the disclosure.

In many embodiments, the device 1500 may include an environment 1502, which may represent the overall operational context or physical assembly, such as a baseboard or a motherboard, in physical embodiments that can be configured as a printed circuit board with a multitude of components or devices connected by way of a system bus or other electrical communication paths. Conceptually, in virtualized embodiments, the environment 1502 may be a virtual environment that encompasses and executes the remaining components and resources of the device 1500. In a number of embodiments, CPU(s) 1504 such as, but not limited to, central processing units, can be configured to operate in conjunction with a chipset 1506. The CPU(s) 1504 can be standard programmable CPUs that perform arithmetic and logical operations that may support the operation of the device 1500.

In a variety of embodiments, the CPU(s) 1504 can perform one or more operations by transitioning from one discrete, physical state to the next through the manipulation of switching elements that differentiate between and change these states. Switching elements generally can include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, or the like. Furthermore, the CPU(s) 1504 may utilize these complex logic circuits to swiftly process network roaming requests and dynamically calculate appropriate timing constraints.

In various embodiments, the chipset 1506 may provide an interface between the CPU(s) 1504 and the remainder of the components and devices within the device 1500. The chipset 1506 can provide an interface to a random-access memory (RAM 1508), which can be utilized as the main memory in the device 1500 in some embodiments. The chipset 1506 can further be configured to provide an interface to a computer-readable storage medium such as a read-only memory (ROM 1510) or a non-volatile RAM for storing basic routines that can help with various tasks such as, but not limited to, starting up the device 1500 and/or transferring information between the various components and devices. The ROM 1510 or non-volatile RAM can also store other application components that may support the operation of the device 1500 in accordance with various embodiments described herein.

Different embodiments of the device 1500 can be configured to operate in a networked environment using logical connections to remote computing devices and computer systems through a network, such as a local area network 1540. The chipset 1506 can include functionality for providing network connectivity through a network interface controller 1512, which may include a gigabit Ethernet adapter, a high-speed serialization/deserialization interface, a wireless transceiver, or similar component. The network interface controller 1512 can be capable of connecting the device 1500 to other devices over the local area network 1540. It is contemplated that a network interface controller 1512, or multiple, may be present in the device 1500, connecting the device 1500 to other types of networks and remote systems, while the device 1500 may also include other devices connected to an input/output controller 1516 or system bus.

In more embodiments, the device 1500 can be connected to a storage 1518 that provides non-volatile storage for data accessible by the device 1500. The storage 1518 can, for example, store an operating system 1520, programs 1522, deadline interval data 1528, network condition data 1530, and roaming context data 1532, which are described in greater detail below. The storage 1518 can be connected to the main system components through a storage controller 1514 connected to the chipset 1506 or system bus. In additional embodiments, the storage 1518 can include one or more physical storage units.

The storage controller 1514 can interface with the physical storage units through interfaces such as a serial advanced technology attachment interface, a fiber channel interface, a serial attached small computer system interface, or other type of interface for physically connecting and transferring data between computers and physical storage units. The device 1500 can store data within the storage 1518 by transforming the physical state of the physical storage units to reflect the information being stored. The specific transformation of the physical state can depend on various factors. Examples of such factors can include, but are not limited to, the technology utilized to implement the physical storage units, whether the storage 1518 is characterized as primary or secondary storage, and the like.

For example, the device 1500 can store information within the storage 1518 by issuing instructions through the storage controller 1514 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided to facilitate this description. The device 1500 can further read or access information from the storage 1518 by detecting the physical states or characteristics of one or more particular locations within the physical storage units. In addition to the storage 1518 described above, the device 1500 can have access to other computer-readable storage media to store and retrieve information, such as program modules, data structures, or other data.

It should be appreciated by those skilled in the art that computer-readable storage media is any available media that provides for the non-transitory storage of data and that can be accessed by the device 1500. In some examples, the operations performed by a cloud computing network, and or any components included therein, may be supported by one or more devices similar to the device 1500. Stated otherwise, some or all of the operations performed by a cloud computing network, and or any components included therein, may be performed by the device 1500 operating in a cloud-based arrangement. By way of example, and not limitation, computer-readable storage media can include volatile, non-volatile, removable, and non-removable media implemented in any method or technology. Computer-readable storage media includes, but is not limited to, RAM, ROM, erasable programmable ROM, electrically-erasable programmable ROM, flash memory or other solid-state memory technology, compact disc-ROM, digital versatile disk, high definition DVD, BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 1518 can store an operating system 1520 utilized to control the operation of the device 1500. According to one embodiment, the operating system 1520 includes the LINUX operating system. According to another embodiment, the operating system 1520 includes the Windows server operating system from Microsoft Corporation. According to further embodiments, the operating system 1520 can include the UNIX operating system or one of its variants. It should be appreciated that other operating systems can also be utilized, and the storage 1518 can store other system or application programs and data utilized by the device 1500.

In still more embodiments, the storage 1518 or other computer-readable storage media is encoded with computer-executable instructions which, when loaded into the device 1500, may transform the device 1500 from a general-purpose computing system into a special-purpose computer capable of implementing the embodiments described herein. These computer-executable instructions may be stored as programs 1522 and transform the device 1500 by specifying how the CPU(s) 1504 can transition between states, as described above. In still further embodiments, the device 1500 has access to computer-readable storage media storing computer-executable instructions which, when executed by the device 1500, perform the various processes described with regard to the flowcharts of the present disclosure. In still additional embodiments, the device 1500 can also include computer-readable storage media having instructions stored thereupon for performing any of the other computer-implemented operations described herein.

In some more embodiments, the device 1500 can also include one or more input/output controller 1516 for receiving and processing input from a number of input devices, such as a keyboard, a mouse, a touchpad, a touch screen, an electronic stylus, or other type of input device. Similarly, an input/output controller 1516 can be configured to provide output to a display, such as a computer monitor, a flat panel display, a digital projector, a printer, or other type of output device. Those skilled in the art will recognize that the device 1500 may not include all of the components shown in FIG. 15, and can include other components that are not explicitly shown in FIG. 15, or may utilize an architecture completely different than that shown in FIG. 15. As described above, the device 1500 may support a virtualization layer, such as one or more virtual resources executing on the device 1500. In some examples, the virtualization layer may be supported by a hypervisor that provides one or more virtual machines running on the device 1500 to perform functions described herein, wherein the virtualization layer may generally support a virtual resource that performs at least a portion of the techniques described herein.

The seamless roaming management logic 1524, in various embodiments, may represent a dedicated hardware circuit, a programmable logic device, a set of instructions executed by the CPU(s) 1504, or a combination thereof, within the device 1500. This seamless roaming management logic 1524 can be configured to manage and regulate various mobility transitions within the network, particularly those that may be useful for seamless roaming in a multi-link device architecture. It is contemplated that the seamless roaming management logic 1524 can implement processes for receiving roaming preparation requests, dynamically determining roaming timeouts based on target load, and transmitting signaling frames to transitioning client devices. Furthermore, the seamless roaming management logic 1524 could orchestrate the timely deletion of reserved resources if a roaming execution fails to occur before the expiration of the specified interval. This response can be indicative of an outcome related to that or other events.

In certain embodiments, the seamless roaming management logic 1524 can actively monitor inputs such as deadline interval data 1528, network condition data 1530, and roaming context data 1532 to make informed adjustments to roaming parameters. For example, if the network condition data 1530 indicates heavy congestion on a target access point, the seamless roaming management logic 1524 might dynamically assign a much shorter roaming timeout to reduce excessive resource reservation. Similarly, based on the roaming context data 1532, the seamless roaming management logic 1524 could implement dynamic context transfers to maintain continuity for sequence numbers and block acknowledgment agreements as a device moves. The operations of the seamless roaming management logic 1524 may facilitate a stable, uninterrupted transition process for highly mobile users, ensuring efficient bandwidth utilization across the entire seamless mobility domain.

The machine-learning model(s) 1526, in some embodiments, may represent a computational engine or a set of algorithms configured to learn from data and make predictions or decisions without being explicitly programmed for every specific scenario. This machine-learning model(s) 1526 can be executed by the CPU(s) 1504 or specialized hardware within the device 1500 and may interact closely with the seamless roaming management logic 1524. It is contemplated that the machine-learning model(s) 1526 could be trained using deadline interval data 1528 that is historical or simulated, network condition data 1530, roaming context data 1532, and potentially other network performance metrics to identify complex patterns and correlations relevant to mobility management. By leveraging these vast datasets, the machine-learning model(s) 1526 may persistently refine the logic used to balance optimal client transition windows against finite hardware capacities.

In certain embodiments, the machine-learning model(s) 1526 can analyze incoming real-time data and provide predictive insights or optimized control parameters to the seamless roaming management logic 1524. For example, it might predict impending network congestion based on active user density from the network condition data 1530 and historical transition patterns from the roaming context data 1532, allowing the seamless roaming management logic 1524 to take proactive measures. Furthermore, the machine-learning model(s) 1526 could learn optimal settings for generating baseline roaming timeouts under various operating conditions to enhance roaming reliability, potentially adapting these settings over time as the physical deployment scales. This approach, leveraging the machine-learning model(s) 1526, can enable more sophisticated, adaptive, and potentially more efficient operation of the seamless roaming management logic 1524 compared to traditional static threshold methods.

The deadline interval data 1528, in various embodiments, may encompass a range of timing measurements and temporal parameters collected or generated from different points within the device 1500. This data could include, for example, the currently configured baseline roaming timeout, the specific time units assigned to a particular roaming client, or the minimum granularity constraint defined by the seamless mobility domain. The deadline interval data 1528 might also include information about timer expirations, countdown thresholds, or remaining validity periods for active roaming preparations, which can be particularly relevant in environments with dynamically moving clients. The storage and processing of this temporal information can enable the system to precisely track when reserved resources must be either committed or forcefully purged.

In certain embodiments, the seamless roaming management logic 1524 can utilize the deadline interval data 1528 as a key input for its decision-making processes associated with network resource regulation and control. By analyzing the deadline interval data 1528, the seamless roaming management logic 1524 can assess the urgency and timing requirements of pending mobility events within the system. If, for example, the deadline interval data 1528 reveals that a specific client has not executed a roam within its allotted timeframe, this information can trigger corrective actions by the seamless roaming management logic 1524, such as deleting the roaming preparation state to free up vital communication links. Conversely, if the deadline interval data 1528 indicates ample time remains, the logic may simply continue monitoring the link without prematurely terminating the session.

The network condition data 1530, in many embodiments, may represent information pertaining to the operational status, configuration, or activity levels of different components, modules, or communication channels within the device 1500. This data can include, but is not limited to, the active bandwidth utilization, hardware queue depths, and processing loads currently experienced by a target access point multi-link device. The network condition data 1530 might also reflect current settings of programmable routing tables, the operational mode of the network interface controller 1512, or flags indicating specific congestion events across the wireless medium. Accurately monitoring the network condition data 1530 provides the foundation for executing load-aware algorithms that protect the infrastructure from becoming completely saturated.

It is contemplated that the seamless roaming management logic 1524 can process the network condition data 1530 to anticipate or respond to changes in system conditions that could affect roaming stability or bandwidth availability. For example, if the network condition data 1530 indicates that a target access point is heavily congested, the seamless roaming management logic 1524 might proactively adjust the timeout interval element to assign a much shorter roaming execution deadline to incoming clients. Conversely, if the network condition data 1530 shows that the target access point is lightly loaded, the logic might adapt by providing a longer deadline interval, granting devices more flexibility to manage their handovers. The use of the network condition data 1530 can thus enable more context-aware and efficient mobility management by the seamless roaming management logic 1524.

The roaming context data 1532, in some embodiments, may consist of session parameters and connection state information gathered from actively communicating devices within the seamless mobility domain. This data might include the dynamic sequence numbers, packet numbers, block acknowledgment agreements, and cryptographic keys associated with a specific non-access point multi-link device. The roaming context data 1532 can provide the seamless roaming management logic 1524 with insights into the exact communication state of a client and how it must be preserved during a network handover. Storing this contextual state locally or sharing it via a wireless controller ensures that the transitioning client does not need to rebuild its entire connection profile from scratch.

It is contemplated that the seamless roaming management logic 1524 can utilize the roaming context data 1532 to implement efficient transition schemes or rapid session resumption strategies. Since the communication requirements of a device can change as it roams, leading to potential packet loss or connection drops, the seamless roaming management logic 1524 can use the roaming context data 1532 to seamlessly transfer these active sessions to a new target node. For example, it might transfer the specific sequence numbers from the roaming context data 1532 to a neighboring access point during the preparation phase, thereby helping to maintain an uninterrupted data flow as the physical connection shifts. This capability to smoothly migrate the roaming context data 1532 can contribute to the overall robustness, low latency, and reliability of the device 1500 during complex mobility events.

Although a specific embodiment for a device 1500 suitable for configuration with the seamless roaming management logic 1524 for carrying out the various steps, processes, methods, and operations described herein is discussed with respect to FIG. 15, any of a variety of systems and/or processes may be utilized in accordance with embodiments of the disclosure. For example, the seamless roaming management logic 1524 could interface with additional types of external controllers beyond those explicitly shown, or the machine-learning model(s) 1526 could be implemented using a distributed architecture across multiple processing elements within the device 1500. Additionally, the specific configuration of internal storage and logic blocks could be adapted to fit entirely cloud-based, virtualized environments. The elements depicted in FIG. 15 may also be interchangeable with other elements of FIGS. 1–14 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous,” “exemplary,” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
a processor;
at least one network interface controller configured to provide access to a network; and
a memory communicatively coupled to the processor, wherein the memory comprises a roaming management logic that is configured to:
transmit a roaming timeout to a client device in a first frame;
receive a roaming preparation request from the client device to prepare a target AP MLD for seamless roaming;
send a roaming preparation response to the client device;
receive a roaming execution request from the client device prior to an expiration of the roaming timeout; and
transmit a roaming execution response to the client device.

2. The network device of claim 1, wherein the first frame is a beacon frame, a probe response frame or a (re)association response frame.

3. The network device of claim 2, wherein the roaming timeout is advertised in a seamless mobility domain element in the first frame.

4. The network device of claim 1, wherein the roaming management logic is further configured to:
determine a specific roaming timeout for the client device;
generate a signaling frame containing the specific roaming timeout; and
transmit the signaling frame to the client device.

5. The network device of claim 4, wherein the network device comprises an access point multi-link device, and wherein the client device comprises a non-access point multi-link device.

6. The network device of claim 4, wherein determining the specific roaming timeout comprises providing a longer interval when the target AP MLD is lightly loaded , and providing a shorter interval when the target AP MLD is heavily loaded.

7. The network device of claim 4, wherein the signaling frame is the roaming preparation response.

8. The network device of claim 4, wherein the specific roaming timeout is provided within a timeout interval element of the signaling frame.

9. The network device of claim 4, wherein the roaming timeout transmitted in the first frame is a baseline roaming timeout for a seamless mobility domain, and wherein the specific roaming timeout in the signaling frame overrides the baseline roaming timeout for the client device.

10. The network device of claim 1, wherein the roaming execution response indicates an outcome of a roaming execution.

11. The network device of claim 1, wherein the network device and the target AP MLD are part of a same seamless mobility domain.

12. The network device of claim 1, wherein the roaming management logic is further configured to delete a roaming preparation for the client device from the target AP MLD if the client device does not perform a roaming execution within the roaming timeout.

13. A client device, comprising:
a processor;
at least one wireless transceiver; and
a memory communicatively coupled to the processor, wherein the memory comprises a roaming management logic that is configured to:
receive a roaming timeout from an access point multi-link device (AP MLD) in a first frame;
transmit a roaming preparation request to the AP MLD to prepare a target AP MLD for seamless roaming;
receive a roaming preparation response from the AP MLD;
transmit a roaming execution request to the target AP MLD prior to an expiration of the roaming timeout; and
receive a roaming execution response from the target AP MLD.

14. The client device of claim 13, wherein the first frame is a beacon frame, a probe response frame or a (re)association response frame.

15. The client device of claim 14, wherein the roaming timeout is received in a seamless mobility domain element in the first frame.

16. The client device of claim 13, wherein the roaming management logic is further configured to:
receive a signaling frame containing a roaming timeout; and
perform a roaming execution to the target AP MLD prior to expiration of the roaming timeout.

17. The client device of claim 16, wherein the signaling frame is a roaming preparation response.

18. The client device of claim 16, wherein the roaming timeout is provided within a timeout interval element of the signaling frame.

19. The client device of claim 13, wherein the client device comprises a non-access point multi-link device.

20. A method of seamless network roaming, comprising:
transmitting a roaming timeout to a client device in a first frame;
receiving a roaming preparation request from the client device to prepare a target AP MLD for seamless roaming;
transmitting a roaming preparation response to the client device;
receiving a roaming execution request from the client device prior to an expiration of the roaming timeout; and
transmitting a roaming execution response to the client device.
